(19) United States
(12) Patent Application Publication
(10) Pub. No.: US 2020/0322595 A1
(43) Pub. Date: Oct. 8, 2020

(54) INFORMATION PROCESSING DEVICE AND INFORMATION PROCESSING METHOD, AND RECORDING MEDIUM

(71) Applicant: SONY CORPORATION, TOKYO (JP)

(72) Inventors: SHINICHIRO ABE, KANGAWA (JP); SHUNICHI HOMMA, TOKYO (JP)

(21) Appl. No.: 16/305,192

(22) PCT Filed: Jun. 5, 2017
(86) PCT No.: PCT/JP2017/020760

§ 371 Date: Nov. 28, 2018

(30) Foreign Application Priority Data
Jun. 7, 2016 (JP) 2016-113241

(51) Int. Cl. H04N 13/383; G06F 3/01; H04N 13/344

(52) U.S. Cl. CPC H04N 13/383; H04N 2013/0081; H04N 13/344; G06F 3/013

(57) ABSTRACT

The present disclosure relates to an information processing device and an information processing method that enable achievement of an improvement regarding the localization of a visual line, for example, in pointing or an object operation with the visual line, and a recording medium.

A display device is controlled such that a stereoscopic object is displayed, the stereoscopic object being disposed in a predetermined direction in a visual field of a user, the stereoscopic object indicating distance regarding the predetermined direction. The present disclosure can be applied to a wearable display device, such as a head-mounted display and the like.

### TECHNICAL FIELD

The present disclosure relates to an information processing and an information processing method, and a recording medium, and particularly relates to an information processing device and an information processing method that enable, for example, a comfortably handsfree operation with achievement of an improvement regarding the localization of a visual line, in pointing or an object operation with the visual line, and a recording medium.

### BACKGROUND ART

A number of devices and methods for an operation of an object in real-world three-dimensional space, including a dedicated device, such as a 3-dimension (3D) mouse, gesture with a fingertip, and the like have been proposed (refer to Patent Document 1).

### CITATION LIST

### Patent Document

Patent Document 1: Japanese Patent Publication No. 5807686

### SUMMARY OF THE INVENTION

### Problems to be Solved by the Invention

However, for the dedicated device, such as the 3D mouse, it is necessary that the dedicated device is operated by hand. For the gesture with a fingertip, the latency of pointing is large.

Furthermore, due to a human vison-adjustment mechanism, it is desirable that an improvement regarding the localization of a visual line is made in pointing or an object operation with the visual line.

The present disclosure has been made in consideration of the situations, and an object of the present disclosure is to enable an improvement regarding the localization of a visual line, to be achieved.

### Solutions to Problems

An information processing device according to the present disclosure, includes a display control unit that controls a display device such that a stereoscopic object is displayed, the stereoscopic object being disposed in a predetermined direction in a visual field of a user, the stereoscopic object indicating distance regarding the predetermined direction. A recording medium according to the present disclosure records a program for causing a computer to function as the information processing device.

An information processing method according to the present disclosure, includes controlling a display device such that a stereoscopic object is displayed, the stereoscopic object being disposed in a predetermined direction in a visual field of a user, the stereoscopic object indicating distance regarding the predetermined direction.

According to the present disclosure, a stereoscopic object is displayed on a display device, the stereoscopic object being disposed in a predetermined direction in a visual field of a user, the stereoscopic object indicating distance regarding the predetermined direction.

### Effects of the Invention

According to the present disclosure (the present technology), a displayed stereoscopic object assists localization of a visual field of a user in three-dimensional space. As a result, for example, an operation can be comfortably performed in a handsfree manner.

Note that, the effects described in the present specification are just exemplifications. The effects of the present technology are not limited to the effects described in the present specification, and thus additional effects may be provided.

### BRIEF DESCRIPTION OF DRAWINGS

FIG. 1 is a diagram for describing an overview of the present technology.

FIG. 2 is a diagram for describing a virtual object operation (Example 1).

FIG. 3 is a diagram for describing a real object operation in a real world (Example 2).

FIG. 4 is a diagram for describing a virtual camera visual-point movement in a virtual world (Example 3).

FIG. 5 is a diagram of illustrating an exemplary different virtual measure.

FIG. 6 is a diagram for describing exemplary object fine-adjustment.

FIG. 7 is a diagram for describing exemplary object fine-adjustment in Example 1.

FIG. 8 is a diagram for describing the exemplary object fine-adjustment in Example 1.

FIG. 9 is a diagram for describing exemplary object fine-adjustment in Example 2.

FIG. 10 is a diagram for describing the exemplary object fine-adjustment in Example 2.

FIG. 11 is a diagram for describing exemplary object fine-adjustment in Example 3.

FIG. 12 is a diagram for describing the exemplary object fine-adjustment in Example 3.

FIG. 13 is a diagram illustrating an exemplary configuration of the external appearance of a wearable display device to which the present technology has been applied.

FIG. 14 is a block diagram illustrating an exemplary configuration of the wearable display device of FIG. 13.

FIG. 15 is a flowchart for describing virtual-object operation processing.

FIG. 16 is a flowchart for describing environment recognition processing at step S11 of FIG. 15.

FIG. 17 is a flowchart for describing visual-line estimation processing at step S12 of FIG. 15.

FIG. 18 is a flowchart for describing drawing processing at step S13 of FIG. 15.

FIG. 19 is a diagram illustrating an exemplary configuration of the external appearance of a wearable display device to which the present technology has been applied.

FIG. 20 is a block diagram illustrating an exemplary configuration of the wearable display device of FIG. 19.

FIG. 21 is a flowchart for describing real-object operation processing.

FIG. 22 is a flowchart for describing visual-line estimation processing at step S112 of FIG. 21.

FIG. 23 is a flowchart for describing drone control processing at step S114 of FIG. 21.

FIG. 24 is a diagram illustrating an exemplary configuration of the external appearance of a wearable display device to which the present technology has been applied.

FIG. 25 is a block diagram illustrating an exemplary configuration of the wearable display device of FIG. 24.

FIG. 26 is a flowchart for describing visual-line estimation processing at step S12 of FIG. 15.

FIG. 27 is a diagram illustrating the relationship between coordinate systems according to the present technology.

FIG. 28 is a diagram for describing a method of acquiring a 3D gaze point in virtual space, according to the present technology.

FIG. 29 is a diagram for describing a method of acquiring a 3D gaze point in virtual space, according to the present technology.

FIG. 30 is a block diagram illustrating an exemplary configuration of an image processing system to which the present technology has been applied.

FIG. 31 is a block diagram illustrating an exemplary configuration of the hardware of a personal computer.

### MODE FOR CARRYING OUT THE INVENTION

Modes for carrying out the present disclosure (hereinafter, referred to as embodiments) will be described below. Note that the descriptions will be given in the following order.

1. First Embodiment (Overview)

2. Second Embodiment (Virtual Object Operation)

3. Third Embodiment (Real Object Operation)

4. Fourth Embodiment (Virtual Camera Visual-Point Movement)

5. Additional Descriptions

6. Fifth Embodiment (Image Processing System)

### 1. First Embodiment

### Overview

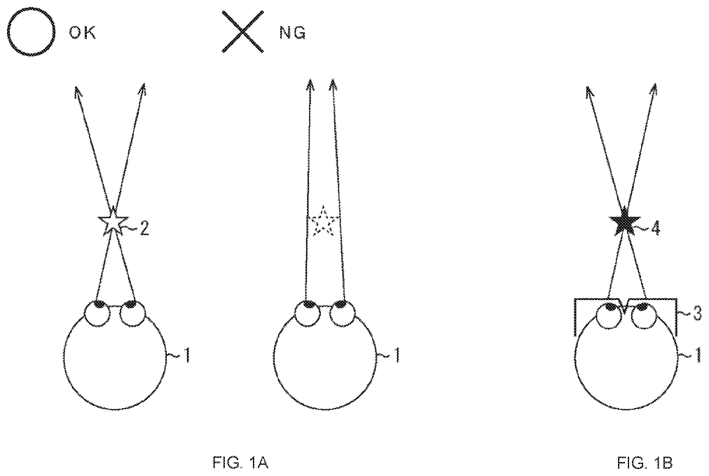

First, an overview of the present technology will be described with reference to FIG. 1.

A number of devices and methods for an operation of an object in real-world three-dimensional space, including a dedicated device, such as a 3-dimension (3D) mouse, gesture with a fingertip, and the like have been proposed. However, for the dedicated device, such as the 3D mouse, it is necessary that the dedicated device is operated by hand. For the gesture with a fingertip, the latency of pointing is large.

Furthermore, for midair (empty-field), a visual line cannot be localized (referred to as empty-field-myopia) due to a human vison-adjustment mechanism, and thus pointing or an object operation with the visual line is difficult to perform.

In other words, as illustrated in A of FIG. 1, when a visually recognizable object A is present, a user 1 can focus thereon. In contrast to this, although the user 1 desires to focus on the position of the object A so as to gaze, when no object is present as indicated with a dotted-line star, the user 1 has difficulty in focusing.

Thus, according to the present technology, even when no real object is present, display of a virtual measure 4 in a wearable display device 3 assists the user 1 in focusing. In other words, according to the present technology, as illustrated in B of FIG. 1, display control of displaying the virtual measure 4 that is a virtual object that assists the visual line in localizing in midair, is performed in the wearable display device 3 (display device), so that the focusing of the user 1 is assisted. The virtual measure 4 that is one stereoscopic object including a virtual object to be viewed stereoscopically (visible stereoscopically), is disposed, for example, in a predetermined direction, such as a depth direction extending ahead of the user 1, a horizontal direction, an oblique direction, or a bent direction, in the visual field of the user 1, and indicates distance in the predetermined direction. The virtual measure 4 assists the visual line in localizing in the midair, and makes an improvement such that the localizing of the visual line into the midair is facilitated. Note that the wearable display device 3 includes, for example, a see-through display, a head-mounted display, or the like.

This arrangement can achieve three-dimensional pointing including midair space, with the visual line and the virtual measure.

### Example 1: Exemplary Virtual Object Operation

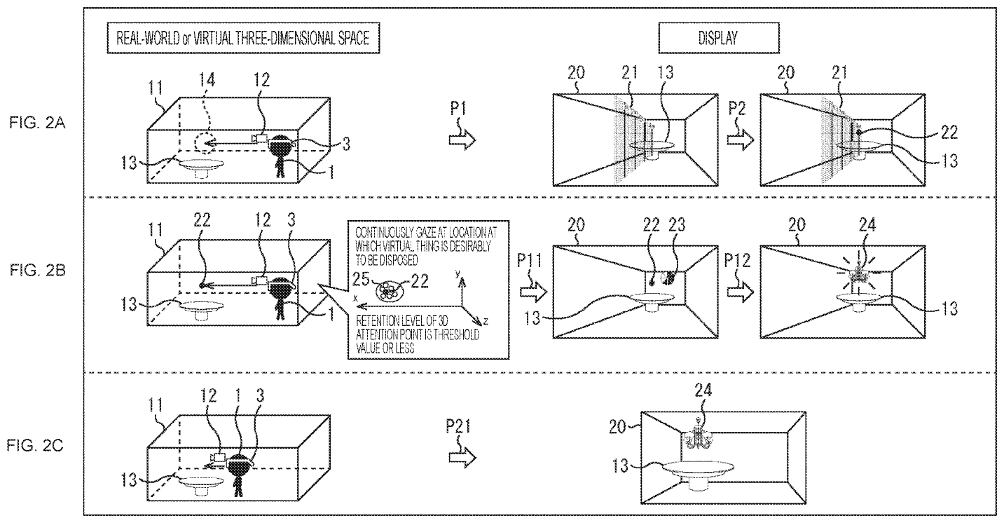

FIG. 2 is a diagram for describing exemplary disposition simulation of virtual furniture as a virtual object operation. In the example of FIG. 2, a user 1 who is wearing a wearable display device 3 is located in real-world three-dimensional space (or virtual three-dimensional space) 11. A table 13 is disposed as one piece of furniture in the real-world three-dimensional space 11. The wearable display device 3 is provided with an environment recognition camera 12 that captures an image of the inside of the real-world three-dimensional space 11 in order to recognize the environment, and a display 20. Then, on the right side of FIG. 2, the image captured by the environment recognition camera 12 in the real-world three-dimensional space 11 (the image of the inside of the real-world three-dimensional space 11), is displayed on the display 20.

As illustrated in A of FIG. 2, although the user 1 attempts to dispose a virtual thing into an empty-field 14 above the table 13 in the real-world three-dimensional space 11, namely, in midair, the user 1 cannot focus on the empty-field 14 above the table 13 in the real-world three-dimensional space 11 due to the human vison-adjustment mechanism as described above.

Thus, the wearable display device 3 displays, as indicated with an arrow P1, a virtual ruler 21 having a scale that enables a gaze, onto the display 20 displaying the inside of the real-world three-dimensional space 11. This arrangement enables the user 1 to focus on, with the virtual ruler 21, a desired position 22 on the virtual ruler 21, as indicated with an arrow P2. Note that the desired position 22 is displayed on the virtual ruler 21 when the user 1 focuses on the position.

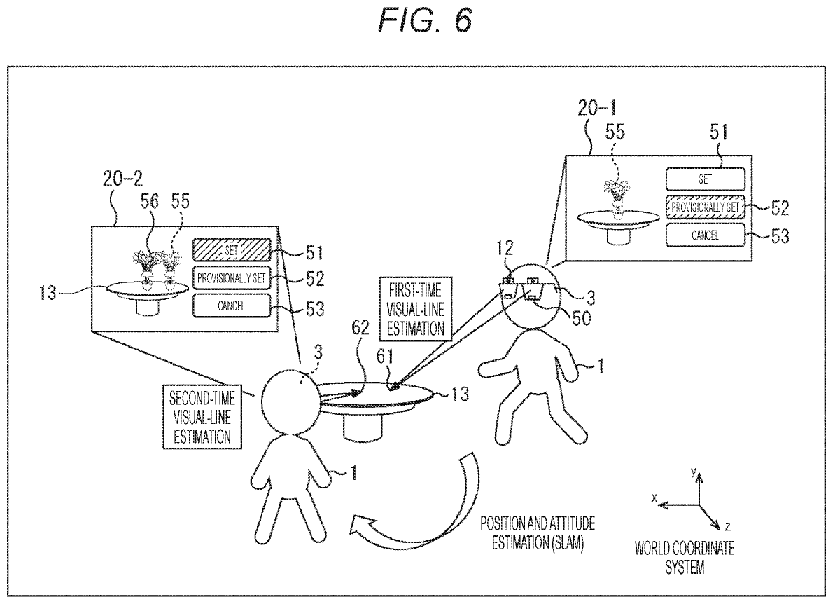

In other words, the wearable display device 3 displays the virtual ruler 21 that is one example of the virtual measure 4, onto the display 20 displaying the inside of the real-world three-dimensional space 11. The virtual ruler 21 includes a flat-shaped stereoscopic object imitating a ruler, and has a scale having substantially regular intervals as information indicating distance. For example, the virtual ruler 21 is disposed slightly obliquely in a region (space) including the midair in which no object visible stereoscopically in the real space is present, with a longitudinal direction (a direction in which the scale is added) along the depth direction and a lateral direction facing vertically, in the visual field of the user 1. Note that the disposition direction in which the virtual ruler 21 (longitudinal direction) is disposed, is not limited to the depth direction. Furthermore, the disposition timing of the virtual measure 21 may be determined on the basis of retention of the visual line or may be determined on the basis of an operation of the user 1 on a graphical user interface (GUI), such as a setting button 51 illustrated in FIG. 6 to be described later.

While the user 1 is continuously gazing at the desired position 22 at which the user 1 desires to dispose the virtual thing, as illustrated in B of FIG. 2, the wearable display device 3 measures whether the retention level of a 3D attention point is a threshold value or less. Here, a circle surrounding the desired position 22 indicates a retention-level threshold range 25 in which the retention level of the 3D attention point is the threshold value or less. Then, as indicated with an arrow P11, the wearable display device 3 displays, at a location at which the retention level of the 3D attention point on the display 20 is the threshold value or less, the desired position 22 indicating the location, and displays a progress mark 23 indicating that the same position is being viewed, in the neighborhood of the desired position 22. Thereafter, as indicated with an arrow P12, the virtual thing 24 can be set in the empty-field 14.

In other words, the wearable display device 3 determines the gaze of the user 1, on the basis of the intersection between the visual line of the user 1 and the virtual ruler 21. In other words, the intersection between the visual line of the user 1 and the virtual ruler 21, is detected in the wearable display device 3. The intersection is a point to which the user 1 attempts to give attention with performance of focusing (with fixation of the visual line) (a point on which the user 1 fixes the visual line in the real-world three-dimensional space or the virtual three-dimensional space), and hereinafter is also referred to as the 3D attention point. As illustrated in B of FIG. 2, the wearable display device 3 determines whether a retention level corresponding to a level of retention range in which the 3D attention point is being retained, is the threshold value or less over a predetermined period (retention-level threshold determination). For example, in a case where the retention level is the threshold value or less over the predetermined period, the wearable display device 3 determines that the user 1 has gazed at the position 22 in the retention range of the 3D attention point. Therefore, while the user 1 is continuously performing the focusing on the position 22 (continuously fixing the visual line), it is determined that the user 1 has gazed. During the performance of the retention-level threshold determination, the wearable display device 3 displays, at the position 22 in the retention range in which the retention level of the 3D attention point on the display 20 is the threshold value or less, a point as an object indicating the position 22, and displays the progress mark 23 indicating the progress of the state in which the same position 22 is being viewed, in the neighborhood of the position 22, as indicated with the arrow P11. The progress mark 23 indicates the time (elapse) during which the retention level is the threshold value or less. After it is determined that the user 1 has gazed at the position 22, for example, the position 22 is regarded as a 3D gaze point at which the user 1 is gazing at, and the wearable display device 3 sets the virtual thing 24 at the position 22, as indicated with the arrow P12.

Then, after the setting of the virtual thing 24, as illustrated in C of FIG. 2, when the user 1 strikes any pose, such as coming close to the table 13, or the like in the real-world three-dimensional space 11, as indicated with an arrow P21, the wearable display device 3 displays, in response to the pose of the user 1, the virtual thing 24 onto the display 20 with simultaneous localization and mapping (SLAM) to be described later with reference to FIG. 6. Therefore, the user can verify the virtual thing 24 in response to the pose of the user 1.

### Example 2: Exemplary Real Object Operation

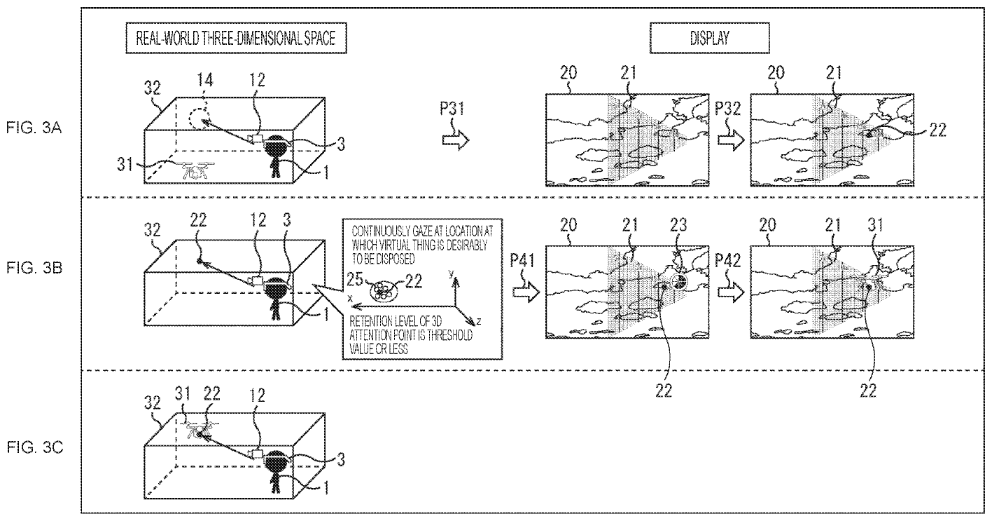

FIG. 3 is a diagram for describing an exemplary drone operation as a real object operation in a real world. In the example of FIG. 3, a user 1 who is wearing a wearable display device 3 is located in real-world three-dimensional space 32. A drone 31 is disposed in the real-world three-dimensional space 32. The wearable display device 3 is provided with an environment recognition camera 12 and a display 20, similarly to the example of FIG. 2. On the right side of FIG. 3, an image captured by the environment recognition camera 12 (an image of the sky having clouds floating) in the real-world three-dimensional space 32, is displayed on the display 20.

As illustrated in A of FIG. 3, even when the user 1 attempts to move the drone 31 into an empty-field 14 that is midair in the real-world three-dimensional space 32, the user 1 cannot focus on the empty-field 14 in the real-world three-dimensional space 32 due to the human vison-adjustment mechanism as described above.

Thus, as indicated with an arrow P31, the wearable display device 3 displays a virtual ruler 21 that enables a gaze, onto the display 20. This arrangement enables the user 1 to focus on, with the virtual ruler 21, a desired position 22 in the empty-field 14, as indicated with an arrow P32.

While the user 1 is continuously gazing at the desired position 22 to which the user 1 desires to move the drone 31, as illustrated in B of FIG. 3, the wearable display device 3 measures whether the retention level of a 3D attention point is a threshold value or less. Then, as indicated with an arrow P41, the wearable display device 3 displays, at a location at which the retention level of the 3D attention point on the display 20 is the threshold value or less, the desired position 22 indicating the location, and displays a progress mark 23 indicating that the same position is being viewed, in the neighborhood of the desired position 22. Thereafter, as indicated with an arrow P42, the drone 31 can be moved into the empty-field 14 (desired position 22 thereof). Note that, in practice, the wearable display device 3 transmits positional information to the drone 31, to move the drone 31.

In other words, while the user 1 is continuously fixing the visual line at the position 22 to which the user 1 desires to move the drone 31, an object indicating the position 22 and the progress mark 23 are displayed (the arrow P41 of B of FIG. 3), similarly to the case of FIG. 2. Thereafter, it is determined that the user 1 has gazed, as indicated with the arrow P42, the drone 31 is moved to the position 22 at which the user 1 is gazing.

Then, after the movement of the drone 31, as illustrated in C of FIG. 3, the user 1 can verify, for example, the drone 31 moved to the desired position 22 in the real-world three-dimensional space 32.

### Example 3: Exemplary Virtual Camera Visual-Point Movement

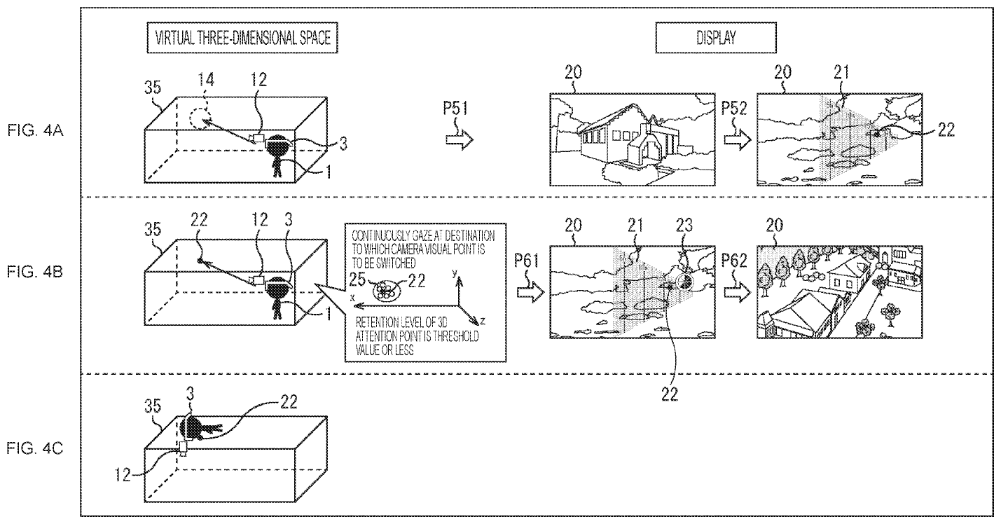

FIG. 4 is a diagram for describing an exemplary visual-point warp as a virtual camera visual-point movement in a virtual world. In the example of FIG. 4, a user 1 who is wearing a wearable display device 3, is located in virtual three-dimensional space 35. The wearable display device 3 is provided with an environment recognition camera 12 and a display 20, similarly to the example of FIG. 2. On the right side of FIG. 4, an image captured by the environment recognition camera 12 (an image of a house viewed diagonally from the front) in the virtual three-dimensional space 35, is displayed on the display 20.

As illustrated in A of FIG. 4, the user 1 who is playing with a subjective visual point, attempts to view an empty-field 14 that is midair and is the position of a visual-point switching destination in the virtual three-dimensional space 35, in order to make a switch to a bird's-eye visual point. However, even when the user 1 attempts to view the empty-field 14 that is the midair, as indicated with an arrow P51, the user 1 cannot focus on the empty-field 14 in the virtual three-dimensional space 35 due to the human vison-adjustment mechanism as described above.

Thus, as indicated with an arrow P52, the wearable display device 3 displays a virtual ruler 21 that enables a gaze, onto the display 20 displaying the midair (an image of the sky in which clouds are floating). The virtual ruler 21 superimposed on the image of the empty-field 14 (namely, the sky), is displayed on the display 20. This arrangement enables the user 1 to focus on, with the virtual ruler 21, a desired position 22 in the visual-point switching destination (empty-field 14), as indicated with an arrow P52.

While the user 1 is continuously gazing at the desired position 22 in the visual-point switching destination, as illustrated in B of FIG. 4, the wearable display device 3 measures whether the retention level of a 3D attention point is a threshold value or less. Then, as indicated with an arrow P61, the wearable display device 3 displays, at a location at which the retention level of the 3D attention point on the display 20 is the threshold value or less, the desired position 22 indicating the location, and displays a progress mark 23 indicating that the same position is being viewed, in the neighborhood of the desired position 22. Thereafter, as indicated with an arrow P62, the camera initial point can be switched to the desired position 22 in the empty-field 14. As a result, an image of the house viewed from above (desired position 22) (bird's-eye image) is displayed on the display 20.

In other words, while the user 1 is continuously fixing the visual line at the desired position 22 in the visual-point switching destination, an object indicating the position 22 and the progress mark 23 are displayed (the arrow P61 of B of FIG. 4), similarly to the case of FIG. 2. Thereafter, it is determined that the user 1 has gazed, as indicated with the arrow P62, the camera visual point (a visual point from which an image to be displayed on the display 20 is viewed) is switched to the position 22 at which the user 1 is gazing. As a result, the image of the house viewed from above (desired position 22) (bird's-eye image) is displayed on the display 20.

Then, for example, as illustrated in C of FIG. 4, the user 1 can have a bird's eye view at the desired position 22 as the camera visual point in the virtual three-dimensional space 35, for example.

### Modification 1: Exemplary Virtual Measure

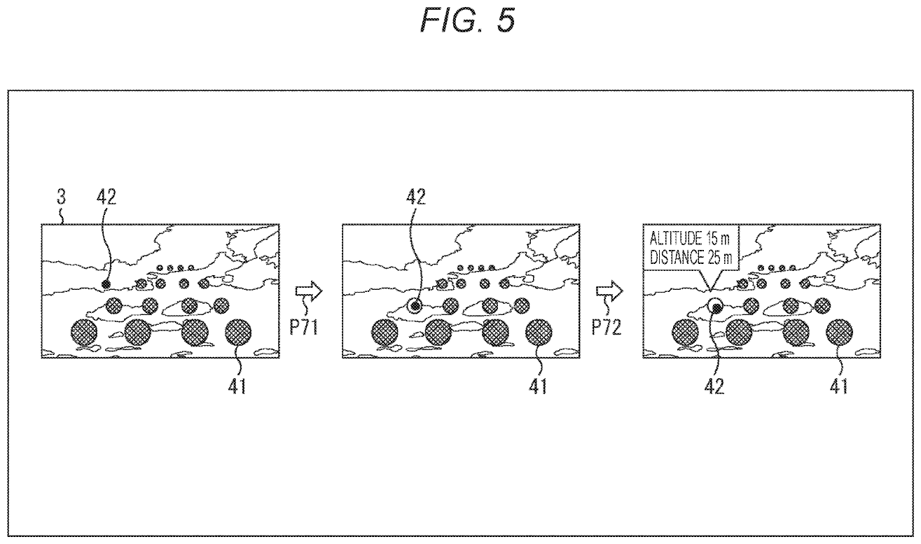

FIG. 5 is a diagram illustrating an exemplary different virtual measure. In the example of FIG. 5, as a virtual measure instead of a virtual ruler 21, spheres 41 as a plurality of virtual objects disposed at substantially regular intervals, are displayed on a display 20. In other words, in FIG. 5, the virtual measure includes the spheres 41 as the plurality of virtual objects, and the plurality of spheres 41 is disposed at the substantially regular intervals correspondingly in a depth direction and a horizontal direction as predetermined directions. The disposition of the plurality of spheres 41 at the substantially regular intervals correspondingly in the depth direction and the horizontal direction, allows the plurality of spheres 41 to indicate distance (interval) correspondingly in the depth direction and the horizontal direction. Although a 2D visual-point pointer 42 of a user 1 is located at a position different from those of the plurality of spheres 41, as indicated with an arrow P71, a gaze can be allowed immediately. The 2D visual-point pointer 42 indicates the position the user 1 is viewing (is performing focusing on).

For example, the color of the sphere 41 at which the 2D visual-point pointer 42 of the user 1 is disposed (namely, the visual line of the user 1 is fixed), is changed, or the like so that feedback can be promptly performed to the user 1. In other words, for the plurality of spheres 41 as the virtual measure, the display of at least one of the plurality of spheres 41 can be changed in response to the visual line of the user 1. Specifically, for example, the color, the luminance, the shape, the size, or the like of the sphere 41 at which the visual line of the user 1 is fixed, can be changed.

Moreover, as indicated with an arrow P72, it is necessary that a display with addition of, for example, additional information indicating the position of the 2D visual-point pointer 42 having “an altitude of 15 m and a distance of 25 m”, to only the sphere 41 at which the 2D visual-point pointer 42 is disposed (namely, the visual line of the user 1 is fixed), facilitates viewing and additionally the visual field of the user 1 is prevented from being obstructed as much as possible. In other words, for the plurality of spheres 41 as the virtual measure, the additional information regarding at least one of the plurality of spheres 41 can be displayed in response to the visual line of the user 1. Specifically, for example, information indicating the position of the sphere 41 at which the visual line of the user 1 is fixed, or the like can be displayed.

Note that, in the example of FIG. 5, although the plurality of spheres is provided, any object may be provided as long as assistance is given. In other words, in the example of FIG. 5, although the virtual measure includes the plurality of spheres, any virtual object having a shape different from a sphere may be provided as long as the focusing of the user 1 is assisted.

### Modification 2: Exemplary Object Fine-Adjustment

Next, object fine-adjustment from a plurality of visual points with SLAM will be described with reference to FIG. 6. Note that the SLAM (position and attitude estimation) is a technique of estimating, with an image of a camera, a map and a position from change information regarding the image, to acquire the position and the attitude of the camera itself in real time.

In the example of FIG. 6, a user 1 who is wearing a wearable display device 3, attempts to set an object on a table 13. The wearable display device 3 is provided with an environment recognition camera 12 and a visual-line recognition camera 50. Thus, a case is assumed where the wearable display device 3 performs first-time visual-line estimation and gaze determination and second-time visual-line estimation and gaze determination. The visual-line estimation includes processing of estimating the visual line of the user 1, and the gaze determination includes processing of determining whether the user 1 has gazed, with the visual line of the user 1. Note that, in FIG. 6, only the description of the “visual-line estimation” is given from the “visual-line estimation” and the “gaze determination”, and the description of the “gaze determination” is omitted.

In the example of FIG. 6, a display 20-1 represents a display 20 after the first-time gaze estimation, and a display 20-2 represents the display 20 after the gaze estimation due to a second-time gaze. In other words, the display 20-1 represents the display 20 after the first-time visual-line estimation and gaze determination, and the display 20-2 represents the display 20 after the second-time visual-line estimation and gaze determination. A setting button 51, a provisionally-setting button 52, and a cancel button 53 displayed on the displays 20-1 and 20-2, each can be selected by gazing. Note that, as indicated with hatching, the display 20-1 has the provisionally-setting button 52 selected, and the display 20-2 has the setting button 51 selected.

In other words, a first-time 3D gaze point 61 is calculated by the first-time visual-line estimation and gaze determination, and is provisionally set as indicated with the hatching of the provisionally-setting button 52. At that time, the display 20-1 displays, on the table 13, an object 55 provisionally set by the gaze in the first-time visual-line estimation. For example, the display is made with dotted lines because of the provisional setting.

Although the user 1 attempts to place the object at the center of the table 13, in practice, as interpreted from the position of the first-time 3D gaze point 61 calculated by the first-time visual-line estimation and gaze determination and the position of a second-time 3D gaze point 62 calculated by the second-time visual-line estimation and gaze determination, there is a possibility that the positions in the depth direction or the like are in disagreement even in agreement in the right-and-left direction.

At this time, the use of the technique of the SLAM in the wearable display device 3, enables the position of the provisionally-set first-time 3D gaze point 61 to be verified with the object 55 on the display 20-2 from a second-time visual point different from a first-time visual point, on the basis of a result of the position and attitude estimation due to the SLAM. Moreover, the first-time 3D gaze point 61 is readjusted from the second-time visual point with verification as an object 56 on the display 20-2, so that the object 56 can be set as indicated with the hatching of the setting button 51. Note that, the display 20-2 displays the object 56 more clearly than the object 55.

Note that specific examples of the object fine-adjustment of FIG. 6 in Examples 1 to 3 will be described individually.

### Object Fine-Adjustment in Example 1

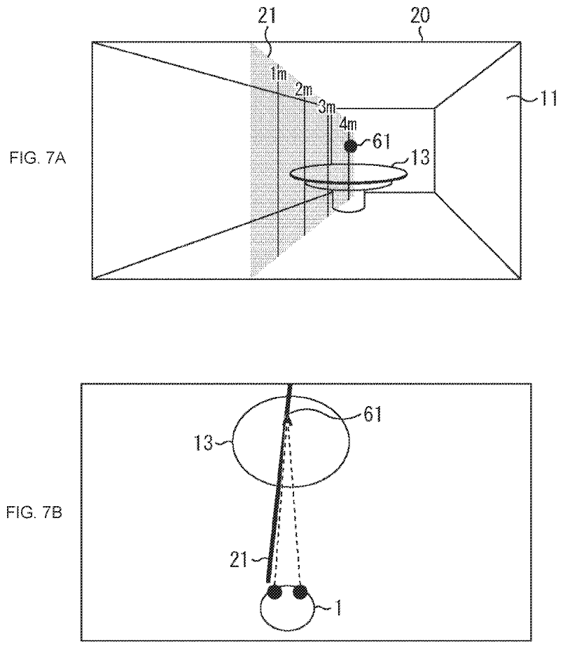

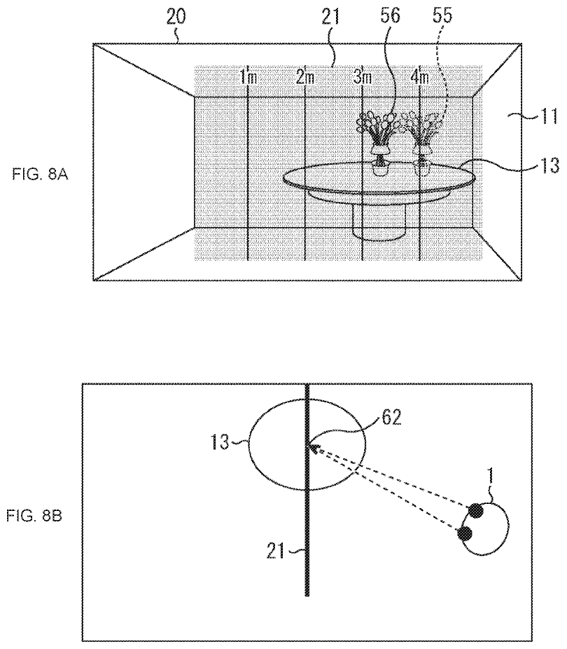

Next, object fine-adjustment with the virtual object operation described in FIG. 2, will be described with reference to FIGS. 7 and 8.

A of FIG. 7 and A of FIG. 8 each illustrate the visual field of the user viewed through the display 20 that is see-through, for example. B of FIG. 7 and B of FIG. 8 are bird's-eye views in world coordinates, illustrating the cases of A of FIG. 7 and A of FIG. 8, respectively.

In the example of A of FIG. 7, the table 13 is disposed as one piece of furniture in the real-world three-dimensional space 11 viewed through the display 20, and the wearable display device 3 displays the virtual ruler 21 having the scale that enables a gaze, on the display 20.

In B of FIG. 7, the virtual ruler 21 is displayed at a constant angle with respect to the facing direction of the user 1. In other words, the virtual ruler 21 is disposed (substantially) in the depth direction in the visual field of the user. Furthermore, the virtual ruler 21 has the scale indicating distance regarding the depth direction, and the scale is disposed (displayed) such that the distance regarding the depth direction is indicated. Note that the intervals of the scale of the virtual ruler 21 and the display direction are not limited to the example of A of FIG. 7 (namely, the user 1 can set the intervals and the display direction). After the intervals and the display direction are determined, the virtual ruler 21 moves in conjunction with movement of the head of the user 1. As illustrated in A of FIG. 7 and B of FIG. 7, a 3D gaze point 61 is acquired at the intersection between the visual line of the user indicated with a dotted-line arrow and the virtual ruler 21, above the table 13.

In the example of A of FIG. 8, the technique of the SLAM causes, after the user 1 moves from the position of B of FIG. 7 to the position illustrated in B of FIG. 8, a result 55 on the gaze point 61 basis before the movement and a result 56 on the current gaze point 62 basis, to be superimposed on the display 20 with the virtual ruler 21 before the movement, remaining displayed. In other words, the object 55 disposed at the 3D gaze point 61 before the movement and the object 56 disposed at the current 3D gaze point 62, are displayed on the display 20. Then, because the virtual ruler 21 before the movement, remains displayed, after the movement of the user 1, the virtual ruler 21 is disposed (substantially) in the horizontal direction when viewed from the user, and the scale included in the virtual ruler 21 indicates distance regarding the horizontal direction.

The user 1 can update the set location that is the result 56 on the current 3D gaze point 62 basis and can perform fine adjustment, any number of times from any position.

### Object Fine-Adjustment in Example 2

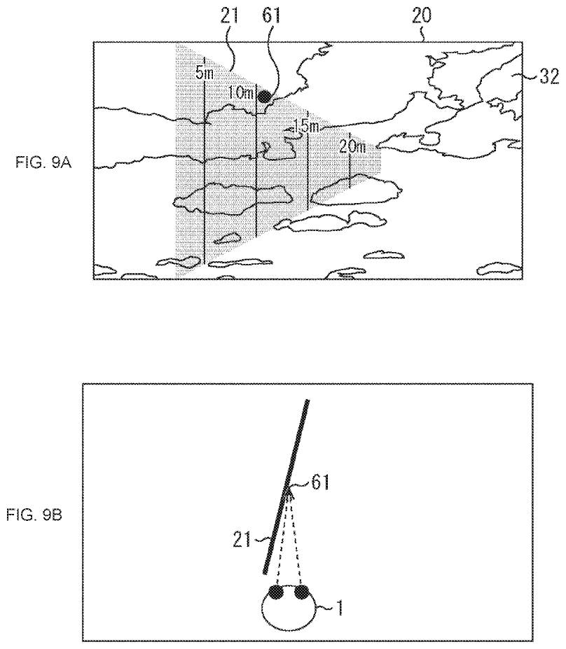

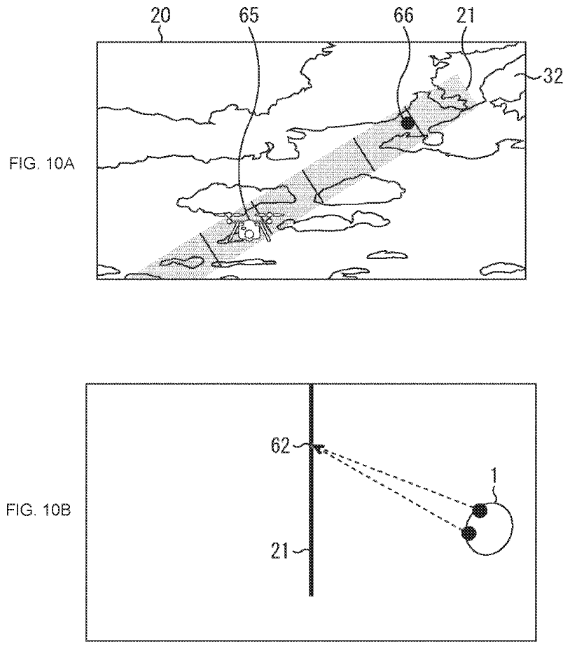

Next, object fine-adjustment with the real object operation described in FIG. 3, will be described with reference to FIGS. 9 and 10.

A of FIG. 9 and A of FIG. 10 each illustrate the visual field of the user viewed through the display 20. B of FIG. 9 and B of FIG. 10 are bird's-eye views in world coordinates, illustrating the cases of A of FIG. 9 and A of FIG. 10, respectively.

In the example of A of FIG. 9, the sky having clouds floating is present in the real-world three-dimensional space 32 viewed through the display 20, and the wearable display device 3 displays the virtual ruler 21 having the scale that enables a gaze, on the display 20.

In B of FIG. 9, the virtual ruler 21 is displayed at a constant angle with respect to the facing direction of the user 1. Note that the intervals of the scale of the virtual ruler 21 and the display direction are not limited to the example of A of FIG. 9 (namely, the user 1 can set the intervals and the display direction). After the intervals and the display direction are determined, the virtual ruler 21 moves in conjunction with movement of the head of the user 1. As illustrated in A of FIG. 9 and B of FIG. 9, a 3D gaze point 61 is acquired at the intersection between the visual line of the user indicated with a dotted-line arrow and the virtual ruler 21.

In the example of A of FIG. 10, the technique of the SLAM causes, after the user 1 moves from the position illustrated in B of FIG. 9 to the position illustrated in B of FIG. 10, a drone 65 drawn at the position of a result on the 3D gaze point 61 basis before the movement and a moved position 66 that is a result on the current 3D gaze point 62 basis, to be superimposed on the display 20 with the virtual ruler 21 before the movement, remaining displayed.

The user 1 can update the moved position 66 that is a result on the current 3D gaze point 62 basis and can perform fine adjustment, any number of times from any position.

### Object Fine-Adjustment in Example 3

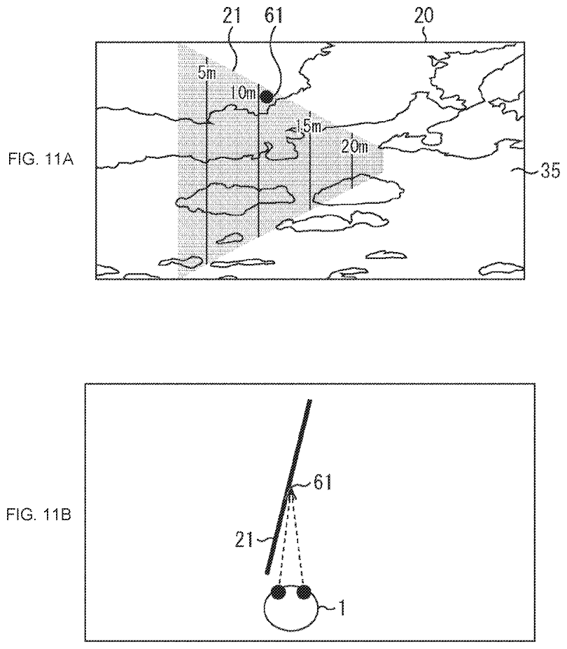

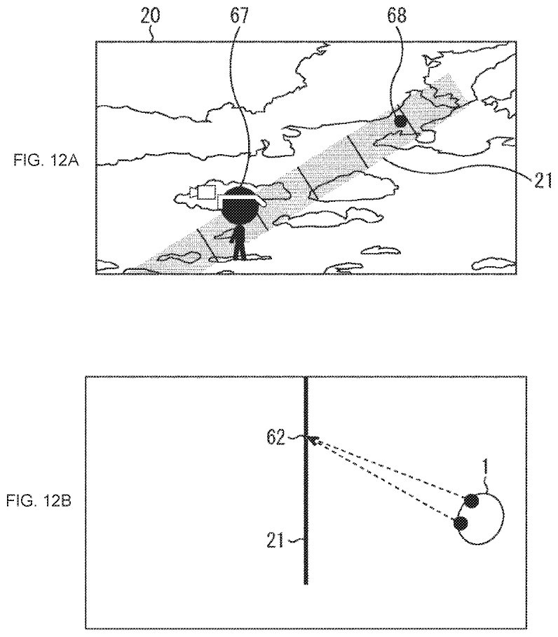

Next, object fine-adjustment with the virtual camera visual-point movement described in FIG. 4, will be described with reference to FIGS. 11 and 12.

A of FIG. 11 and A of FIG. 12 each illustrate the visual field of the user viewed through the display 20. B of FIG. 11 and B of FIG. 12 are bird's-eye views in world coordinates, illustrating the cases of A of FIG. 11 and A of FIG. 12, respectively.

In the example of A of FIG. 11, the sky having clouds floating is present in the virtual three-dimensional space 35 viewed through the display 20, and the wearable display device 3 displays the virtual ruler 21 having the scale that enables a gaze, on the display 20.

In B of FIG. 11, the virtual ruler 21 is displayed at a constant angle with respect to the facing direction of the user 1. Note that the intervals of the scale of the virtual ruler 21 and the display direction are not limited to the example of A of FIG. 11 (namely, the user 1 can set the intervals and the display direction). After the intervals and the display direction are determined, the virtual ruler 21 moves in conjunction with movement of the head of the user 1. As illustrated in A of FIG. 11 and B of FIG. 11, a 3D gaze point 61 is acquired at the intersection between the visual line of the user indicated with a dotted-line arrow and the virtual ruler 21.

In the example of A of FIG. 12, the technique of the SLAM causes, after the user 1 moves from the position illustrated in B of FIG. 11 to the position illustrated in B of FIG. 12, a user itself 67 drawn at the position of a result on the 3D gaze point 61 basis before the movement and a moved position 68 that is a result on the current 3D gaze point 62 basis, to be superimposed on the display 20 with the virtual ruler 21 before the movement, remaining displayed.

The user 1 can update the moved position 68 that is a result on the current 3D gaze point 62 basis and can perform fine adjustment, any number of times from any position.

As described above, according to the present technology, the use of the SLAM (or a position-estimation technique similar to the SLAM or the like) enables the object fine-adjustment to be performed from a plurality of visual points.

Note that the virtual objects to be displayed on the display 20 described above (e.g., a virtual thing, a virtual measure, a progress mark, and a sphere) are stereoscopic images to be viewed stereoscopically (visible stereoscopically), each including a right-eye image and a left-eye image each having a binocular disparity and a vergence angle. That is, each virtual object has a virtual-image position in the depth direction (each virtual object is displayed as if each virtual object is present at a predetermined position in the depth direction). In other words, for example, setting the binocular disparity or the vergence angle enables each virtual object to have a desired virtual-image position (each virtual object is displayed to the user as if each virtual object is present at the desired position in the depth direction).

### 2. Second Embodiment

### External Appearance of Wearable Display Device

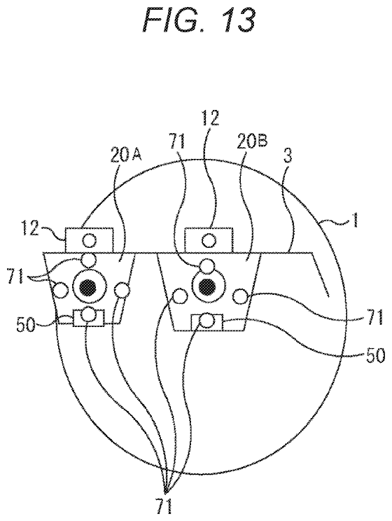

FIG. 13 is a diagram illustrating an exemplary configuration of the external appearance of a wearable display device as an image processing device that is one information processing device to which the present technology has been applied. Note that the wearable display device of FIG. 13 performs the virtual object operation described with reference FIG. 2.

In the example of FIG. 13, the wearable display device 3 has a spectacle type, and is worn on the face of a user 1. The casing of the wearable display device 3 is provided with, for example, a display 20 (display unit) including a right-eye display unit 20A and a left-eye display unit 20B, environment recognition cameras 12, visual-line recognition cameras 50, and LEDs 71.

The lens portions of the wearable display device 3 are included in, for example, the display 20 that is see-through, and the environment recognition cameras 12 are provided at portions above both eyes, on the outside of the display 20. At least one environment recognition camera 12 may be provided. The environment recognition cameras 12 each may include, but are not limited to, an RGB camera.

The LEDs 71 are provided individually up and down, and, right and left around both eyes, the LEDs 71 facing inward (to the face) from the display 20. Note that the LEDs 71 are used for visual-line recognition and preferably at least two LEDs 71 may be provided for one eye. In other words, at least two LEDs 71 may be provided for one eye.

Moreover, the visual-line recognition cameras 50 are provided at portions below both eyes, the visual-line recognition cameras 50 facing inward from the display 20. Note that at least one visual-line recognition camera 50 may be provided for one eye. For visual-line recognition for both eyes, at least two infrared cameras are provided. Furthermore, in visual-line recognition with a corneal reflex method, at least two LEDs 71 are provided for one eye and at least four LEDs 71 are provided for the visual-line recognition for both eyes.

In the wearable display device 3, the portions corresponding to the lenses of a pair of spectacles, are included in the display 20 (the right-eye display unit 20A and the left-eye display unit 20B). When the user 1 wears the wearable display device 3, the right-eye display unit 20A is located in the neighborhood ahead of the right eye of the user 1 and the left-eye display unit 20B is located in the neighborhood ahead of the left eye of the user.

The display 20 includes a transmissive display that transmits light therethrough. Therefore, the right eye of the user 1 can view, through the right-eye display unit 20A, a real-world sight (transmissive image) on the back side thereof, namely, ahead of the right-eye display unit 20A (in front when viewed from the user 1 (in the depth direction)). Similarly, the left eye of the user 1 can view, through the left-eye display unit 20B, a real-world sight (transmissive image) on the back side thereof, namely, ahead of the left-eye display unit 20B. Therefore, the user 1 views an image displayed on the display 20, the image being superimposed on the near side of a real-world sight ahead of the display 20.

The right-eye display unit 20A displays an image (right-eye image) to be viewed to the right eye of the user 1, and the left-eye display unit 20B displays an image (left-eye image) to be viewed to the left eye of the user 1. That is, the display 20 causes each of the right-eye display unit 20A and the left-eye display unit 20B to display an image having a disparity, so that a stereoscopic image to be viewed stereoscopically (stereoscopic object) is displayed.

The stereoscopic image includes the right-eye image and the left-eye image each having the disparity. Controlling the disparity (or vergence angle), namely, for example, controlling, to the position of a subject viewed in one of the right-eye image and the left-eye image, a shift amount in the horizontal direction of the position of the same subject viewed in the other image, enables the subject to be viewed at a position far away from the user 1 or to be viewed at a position near the user 1. That is, the stereoscopic image can be controlled in terms of the depth position (not the actual display position of the image, but the position at which the user 1 views the image as if the image is present thereat (virtual-image position)).

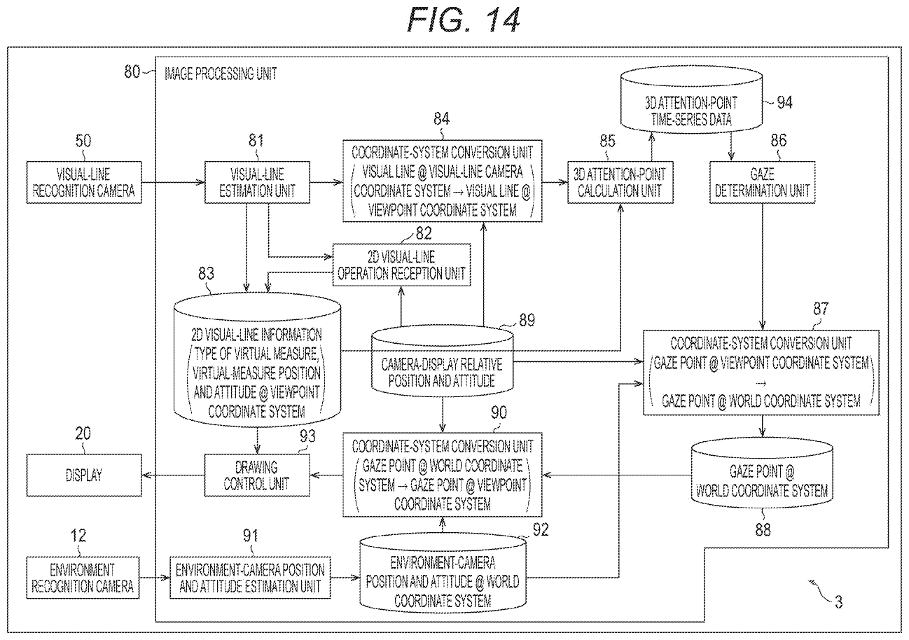

FIG. 14 is a block diagram illustrating an exemplary configuration of the wearable display device of FIG. 13.

In the example of FIG. 14, the wearable display device 3 includes an environment recognition camera 12, a display 20, a visual-line recognition camera 50, and an image processing unit 80. The image processing unit 80 includes a visual-line estimation unit 81, a 2D visual-line operation reception unit 82, a 2D visual-line information DB 83, a coordinate-system conversion unit 84, a 3D attention-point calculation unit 85, a gaze determination unit 86, a coordinate-system conversion unit 87, a gaze-point DB 88, a camera-display relative position and attitude DB 89, a coordinate-system conversion unit 90, a position and attitude estimation unit 91, an environment-camera position and attitude DB 92, a drawing control unit 93, and a 3D attention-point time-series DB 94. Note that the drawing control unit 93 may be exemplarily regarded as at least one of a display control unit or an object control unit according to the present disclosure.

The visual-line estimation unit 81 consecutively estimates the visual line of the user 1 from an image input from the visual-line recognition camera 50. The estimated visual line includes, for example, a “pupillary position” and a “visual-line vector” in a visual-line recognition camera coordinate system having the visual-line recognition camera 50 as the origin. The information is supplied to the 2D visual-line operation reception unit 82, the 2D visual-line information DB 83, and the coordinate-system conversion unit 84. The visual-line recognition adopts, for example, a pupillary and corneal reflex method, but may adopt another visual-line recognition method, such as a sclerotic reflex method, a Double Purkinje method, an image processing method, a search coil method, or an electro-oculography (EOG) method. Note that the visual line of the user 1 may be estimated, for example, as the orientation of the environment recognition camera 12 (the optical axis of the environment recognition camera 12). Specifically, the orientation of the camera to be estimated with an image captured by the camera 12, may be estimated as the visual line of the user. In other words, it should be noted that the adoption of a visual-line recognition method of capturing an eyeball of the user 1 is not essential to the estimation of the visual line of the user 1.

With the visual line from the visual-line estimation unit 81 and data in camera-display relative position and attitude relationship from the camera-display relative position and attitude DB 89, the 2D visual-line operation reception unit 82 acquires 2D visual-line coordinates on the display 20 (2D gaze-point coordinates), receives a menu operation, selects and sets a virtual measure. The 2D visual-line coordinates (2D gaze-point coordinates) on the display 20 means two-dimensional coordinates information regarding where the visual line of the user is located on the display 20.

The 2D visual-line information DB 83 records the menu operation received by the 2D visual-line operation reception unit 82 and information regarding the virtual measure (e.g., the desired position 22 of FIG. 2) as a state. The type of the virtual measure with the 2D visual line and the position and attitude of the virtual measure in a viewpoint coordinate system are recorded in the 2D visual-line information DB 83.

With the data in camera-display relative position and attitude relationship from the camera-display relative position and attitude DB 89, the coordinate-system conversion unit 84 converts the visual line in the visual-line recognition camera coordinate system from the visual-line estimation unit 81, into the visual line in the viewpoint coordinate system of the display 20.

The 3D attention-point calculation unit 85 acquires the intersection between the virtual measure recorded in the 2D visual-line information DB 83 and the visual line in the viewpoint coordinate system converted by the coordinate-system conversion unit 84, and calculates 3D attention-point coordinates. The calculated 3D attention-point coordinates are accumulated in the 3D attention-point time-series DB 94.

In other words, the 3D attention-point calculation unit 85 calculates a 3D attention point that is the intersection between the virtual measure recorded in the 2D visual-line information DB 83 and the visual line in the viewpoint coordinate system converted by the coordinate-system conversion unit 84.

The gaze determination unit 86 determines whether or not the user has gazed, with 3D attention-point time-series data from the 3D attention-point time-series DB 94. The average value, a mode value, or a median (intermediate value) in the time-series data is adopted as the final 3D gaze-point coordinates.

On the speed basis, the gaze determination unit 86 compares the speed of a coordinate variation in the 3D attention-point time-series data in a section, with a threshold value, and determines a gaze when the speed is the threshold value or less. On the dispersion basis, the gaze determination unit 86 compares the dispersion of a coordinate variation in the 3D attention-point time-series data in a section, with a threshold value, and determines a gaze when the dispersion is the threshold value or less. The coordinate variation, the speed, and the dispersion each correspond to the retention level described above. Note that both methods on the speed basis and the dispersion basis can make a determination from a one-eye visual line, but can also use a both-eyes visual line. In that case, the midpoint between the 3D attention points is handled as the 3D attention point of both eyes.

With camera-display relative position and attitude data from the camera-display relative position and attitude DB 89, environment-camera position and attitude in the latest world coordinate system that is a world standard, from the environment-camera position and attitude DB 92, and a 3D gaze point in the viewpoint coordinate system from the gaze determination unit 86, the coordinate-system conversion unit 87 converts the 3D gaze point in the viewpoint coordinate system into the 3D gaze point in the world coordinate system, and records the 3D gaze point into the gaze-point DB 88. The coordinate-system conversion unit 87 can function as a gaze-point calculation unit that calculates the 3D gaze point in the world coordinate system, on the basis of the environment-camera position and attitude (the position and attitude of the user) in the latest world coordinate system that is a world standard, from the environment-camera position and attitude DB 92, and the 3D gaze point (a point acquired from the 3D attention point that is the intersection between the visual line and the virtual measure) in the viewpoint coordinate system from the gaze determination unit 86.

The 3D gaze point in the world coordinate system, converted by the coordinate-system conversion unit 87, is accumulated in the gaze-point DB 88.

Data in position and attitude relationship between the visual-line recognition camera 50, the environment recognition camera 12, and the display 20 is recorded in the camera-display relative position and attitude DB 89. The position and attitude relationship therebetween is calculated in advance in factory calibration.

With the camera-display relative position and attitude data from the camera-display relative position and attitude DB 89, the environment-camera position and attitude in the latest world coordinate system from the environment-camera position and attitude DB 92, and the coordinates of the 3D gaze point in the world coordinate system from the gaze-point DB 88, the coordinate-system conversion unit 90 converts the 3D gaze point in the world coordinate system into the 3D gaze point in the viewpoint coordinate system at the point in time.

The environment-camera position and attitude estimation unit 91 consecutively estimates the position and attitude of the environment recognition camera 12 (the user 1 who is wearing the environment recognition camera 12), from the image of the environment recognition camera 12. Self-position estimation adopts the environment recognition camera 12 and the technique of the SLAM described above. Examples of other self-position estimation technologies include GPS, WIFI, IMU (a triaxial acceleration sensor+a triaxial gyroscope sensor), RFID, visible-light communication positioning, and object recognition (image authentication). Although the techniques have problems in terms of processing speed and precision, the techniques can be used instead of the SLAM. Even for the use of the environment recognition camera 12 and the SLAM, any of the techniques described above is available for standard determination of the world coordinate system (initialization). For example, the environment-camera position and attitude estimation unit 91 can be regarded as a position and attitude estimation unit that estimates the position and attitude of the user who is wearing the wearable display device 3 in the real-world or virtual three-dimensional space.

The environment-camera position and attitude DB 92 records the latest position and attitude at the point in time from the environment-camera position and attitude estimation unit 91.

The drawing control unit 93 controls drawing on the display 20 with the 2D visual line, drawing of the virtual measure, based on the information in the 2D visual-line information DB 83, and drawing of a virtual object at the 3D gaze point, based on the 3D gaze point in the viewpoint coordinate system converted by the coordinate-system conversion unit 90. In other words, the drawing control unit 93 can function as the display control unit that controls the display of the point on the display 20 the user is viewing and the display of the virtual measure, and the display of the virtual object at the 3D gaze point, based on the 3D gaze point in the viewpoint coordinate system converted by the coordinate-system conversion unit 90, or can be function as the object control unit that controls the object. The time-series data of the calculated 3D attention-point coordinates calculated by the 3D attention-point calculation unit 85, is recorded in the 3D attention-point time-series DB 94.

Note that the drawing control unit 93 performs processing of generating a stereoscopic object (stereoscopic image) including a left-eye image and a right-eye image, the stereoscopic object being to be displayed on the display 20 as a drawing. Then, the drawing control unit 93 causes the display 20 to display the generated stereoscopic object.

For example, the drawing control unit 93 sets the virtual-image position of each stereoscopic object. Then, the drawing control unit 93 controls the display 20 to display such that the stereoscopic object is viewed stereoscopically as if the stereoscopic object is present at the virtual-image position set to the stereoscopic object.

In order to display such that the stereoscopic object is viewed stereoscopically as if the stereoscopic object is present at the virtual position set to the stereoscopic object, the drawing control unit 93 sets a disparity or a vergence angle for the stereoscopic object, and generates the left-eye image and the right-eye image as the stereoscopic object having the disparity or the vergence angle occurring. Any method of generating the stereoscopic image, is provided. For example, Japanese Patent Application Laid-Open No. H08-322004 discloses a stereoscopic display device having a means that electrically shifts, in the horizontal direction, an image displayed on a display screen such that the vergence angle to a diopter scale is substantially constant in real time. Furthermore, Japanese Patent Application Laid-Open No. H08-211332 discloses a three-dimensional image reproduction device that acquires a stereoscopic image with a binocular disparity, the three-dimensional image reproduction device having: a vergence-angle selection means that sets a vergence angle for viewing of a reproduction image; and a control means that controls the relative reproduction position between right and left images on the basis of information regarding the selected vergence angle. For example, the drawing control unit 93 can generate the stereoscopic object with any of the described methods.

### Operation of Wearable Display Device

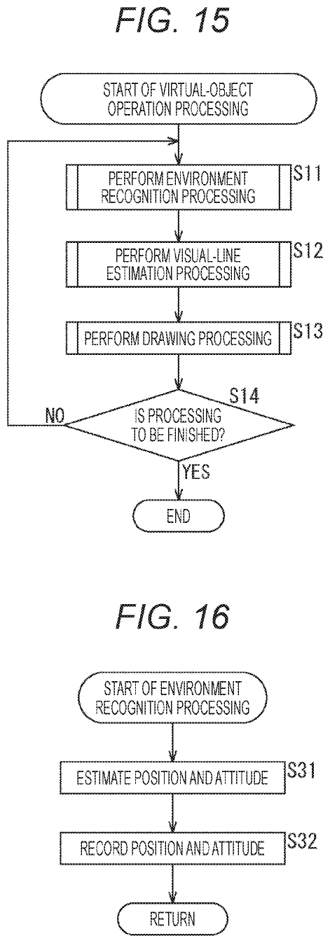

Next, virtual-object operation processing will be described with reference to the flowchart of FIG. 15. Note that each step of FIG. 15 is performed in parallel. In other words, although each step is sequenced, for convenience, in the flowchart of FIG. 15, each step is appropriately performed in parallel. A similar manner is made in a different flowchart.

The image from the environment recognition camera 12 is input into the environment-camera position and attitude estimation unit 91. At step S11, the environment-camera position and attitude estimation unit 91 performs environment recognition processing. Although the details of the environment recognition processing are to be described later with reference to FIG. 16, the processing causes the position and attitude of the environment recognition camera 12, estimated from the image from the environment recognition camera 12, to be recorded into the environment-camera position and attitude DB 92.

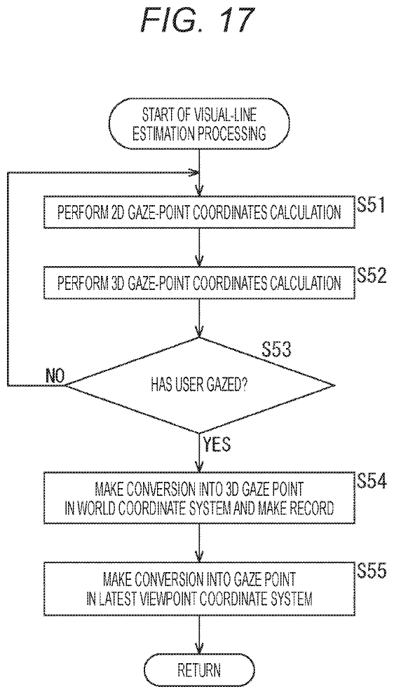

Furthermore, the image input from the visual-line recognition camera 50, is input into the visual-line estimation unit 81. At step S12, the visual-line estimation unit 81, the 2D visual-line operation reception unit 82, the coordinate-system conversion unit 84, the 3D attention-point calculation unit 85, and the gaze determination unit 86 perform visual-line estimation processing. Although the details of the visual-line estimation processing are to be described later with reference to FIG. 17, the processing causes a 2D gaze point to be acquired, a 3D gaze point to be acquired from the 2D gaze point, and the 3D gaze point to be converted into the 3D gaze point in the latest viewpoint coordinate system.

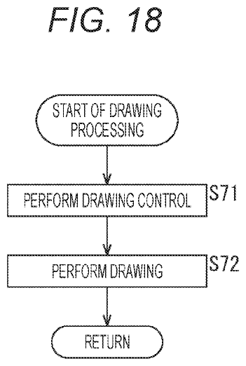

At step S13, the drawing control unit 93 performs drawing processing with the information in the 2D visual-line information DB 83 and the 3D gaze point in the viewpoint coordinate system converted by the coordinate-system conversion unit 90. Although the drawing processing is to be described later with reference to FIG. 18, the processing causes the drawing on the display 20 with the 2D visual line (drawing of the 2D visual-line coordinates on the display 20), the drawing of the virtual measure, and the drawing of the virtual object at the 3D gaze point, to be controlled, so that the drawings are made on the display 20. In other words, the display 20 displays, for example, the virtual measure and the virtual object disposed at the 3D gaze point.

At step S14, the 2D visual-line operation reception unit 82 determines whether or not the virtual-object operation processing is to be finished. At step S14, in a case where it is determined that the virtual-object operation processing is to be finished, the virtual-object processing of FIG. 15 is finished. Meanwhile, at step S14, in a case where it is determined that the virtual-object processing is not to be finished yet, the processing goes back to step S11 and the processing at and after step S11 is repeated.

Next, the environment recognition processing at step S11 of FIG. 15 will be described with reference to the flowchart of FIG. 16.

At step S31, the environment-camera position and attitude estimation unit 91 estimates the position and attitude of the environment recognition camera 12 from the image of the environment recognition camera 12.

At step S32, the environment-camera position and attitude DB 92 records the latest position and attitude at the point in time (the position and attitude of the environment recognition camera 12). The latest position and attitude recorded here are used at steps S54 and S55 of FIG. 17 to be described later.

Next, the visual-line estimation processing at step S12 of FIG. 15 will be described with reference to the flowchart of FIG. 17.

The image input from the visual-line recognition camera 50 is input into the visual-line estimation unit 81. At step S51, the visual-line estimation unit 81 and the 2D visual-line operation reception unit 82 perform 2D gaze-point calculation.

In other words, the visual-line estimation unit 81 consecutively estimates the visual line from the image input from the visual-line recognition camera 50. The estimated visual line includes the “pupillary position” and the “visual-line vector” in the visual-line camera coordinate system, and the information is supplied to the 2D visual-line operation reception unit 82, the 2D visual-line information DB 83, and the coordinate-system conversion unit 84. With the visual line from the visual-line estimation unit 81 and the data in camera-display relative position and attitude relationship from the camera-display relative position and attitude DB 89, the 2D visual-line operation reception unit 82 acquires the 2D visual-line coordinates (2D gaze-point coordinates) on the display 20, receives the menu operation, and selects and sets the virtual measure.

Note that the 2D visual-line information DB 83 records the menu operation received by the 2D visual-line operation reception unit 82 and the information regarding the virtual measure as a state in addition to the 2D visual-line coordinates on the display 20. These pieces of information are used at step S71 of FIG. 18. For example, with the information in the 2D visual-line information DB 83, the drawing control unit 93 causes the display 20 to display the virtual measure.

At step S52, the coordinate-system conversion unit 84 and the 3D attention-point calculation unit 85 calculates the 3D attention-point coordinates. In other words, with the data in camera-display relative position and attitude relationship from the camera-display relative position and attitude DB 89, the coordinate-system conversion unit 84 converts the visual line in the visual-line recognition camera coordinate system, into the visual line in the viewpoint coordinate system. The 3D attention-point calculation unit 85 acquires the intersection between the virtual measure recorded in the 2D visual-line information DB 83 and the visual line in the viewpoint coordinate system converted by the coordinate-system conversion unit 84, and calculates the 3D attention-point coordinates. The calculated 3D attention-point coordinates are accumulated in the 3D attention-point time-series DB 94.

At step S53, the gaze determination unit 86 determines whether or not the user has gazed, with the 3D attention-point time-series data from the 3D attention-point time-series DB 94. At step S53, in a case where it is determined that the user has not gazed, the processing goes back to step S51 and the processing at and after step S51 is repeated. Meanwhile, at step S53, in a case where it is determined that the user has gazed, the gaze determination unit 86 acquires the 3D gaze point at which the user is gazing in the viewpoint coordinate system, with the 3D attention-point time-series data, and the processing proceeds to step S54.

Note that the average value, a mode value, or a median (intermediate value) in the time-series data is adopted as the final 3D gaze-point coordinates.

At step S54, with the camera-display relative position and attitude data from the camera-display relative position and attitude DB 89, the environment-camera position and attitude in the latest world coordinate system from the environment-camera position and attitude DB 92, and the 3D gaze point in the viewpoint coordinate system from the gaze determination unit 86, the coordinate-system conversion unit 87 converts the 3D gaze point in the viewpoint coordinate system into the 3D gaze point in the world coordinate system and records the 3D gaze point in the world coordinate system, into the gaze-point DB 88.

At step S55, with the camera-display relative position and attitude data from the camera-display relative position and attitude DB 89, the environment-camera position and attitude in the latest world coordinate system from the environment-camera position and attitude DB 92, and the coordinates of the 3D gaze point in the world coordinate system from the gaze-point DB 88, the coordinate-system conversion unit 90 converts the 3D gaze point in the world coordinate system into the 3D gaze point in the viewpoint coordinate system at the point in time. Note that the information is used at step S71 of FIG. 18.

Finally, the drawing processing at step S13 of FIG. 15 will be described with reference to the flowchart of FIG. 18.

At step S71, the drawing control unit 93 controls the drawing on the display 20 with the 2D visual line, the drawing of the virtual measure, based on the information in the 2D visual-line information DB 83, and the drawing of the virtual object at the 3D gaze point, based on the 3D gaze point in the viewpoint coordinate system converted by the coordinate-system conversion unit 90.

At step S72, the display 20 performs the drawing under the control of the drawing control unit 93. This arrangement allows, for example, the virtual measure, the virtual object at the 3D gaze point, and the like to be displayed on the display 20.

As described above, according to the present technology, the drawing of the virtual measure enables the localization of the 3D gaze point even to midair to which the localization used to be difficult, namely, enables the localization of the visual line, so that an operation is allowed with the visual line. In other words, an improvement regarding the localization of the visual line, can be made in pointing or an object operation with the visual line. This arrangement enables the virtual object operation to be performed in a handsfree manner. Furthermore, because of the operation with the visual line, the latency of pointing is small.

Moreover, because the 3D gaze point can be acquired from the visual-line recognition and the environment recognition, even while the user is moving, a gaze state can be detected and pointing interaction can be performed.

### 3. Third Embodiment

### External Appearance of Wearable Display Device

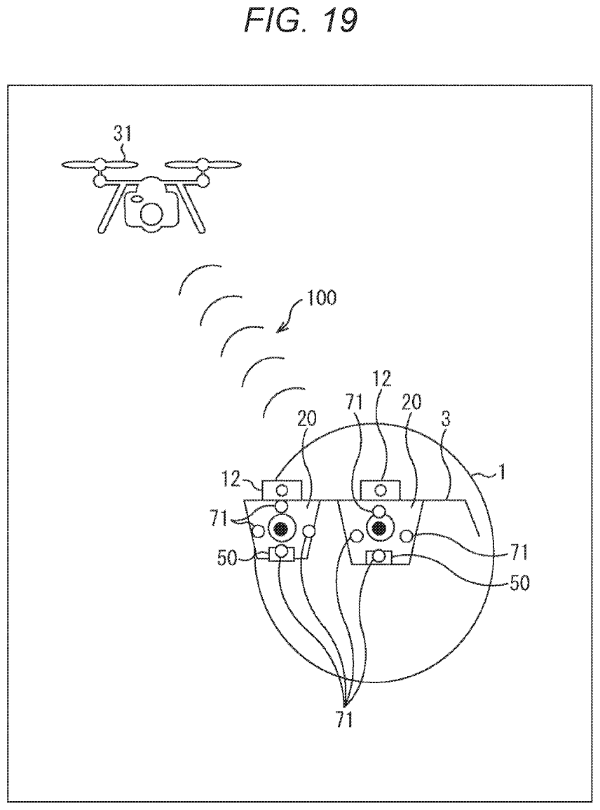

FIG. 19 is a diagram illustrating an exemplary configuration of the external appearance of a wearable display device as an image processing device that is one information processing device to which the present technology has been applied. Note that the wearable display device of FIG. 19 performs the real object operation described above with reference to FIG. 3.

In the example of FIG. 19, similarly to the case of the example of FIG. 13, the wearable display device 3 has a spectacle type, and is worn on the face of a user 1.

The example of FIG. 19 is different from the example of FIG. 13 only in that an object to be operated is changed from a virtual object to be displayed on a display 20 to a real-world drone 31 to be operated through wireless communication 100. The other points are similar to those in the exemplary configuration of the external appearance of FIG. 13, and thus the descriptions thereof will be omitted.

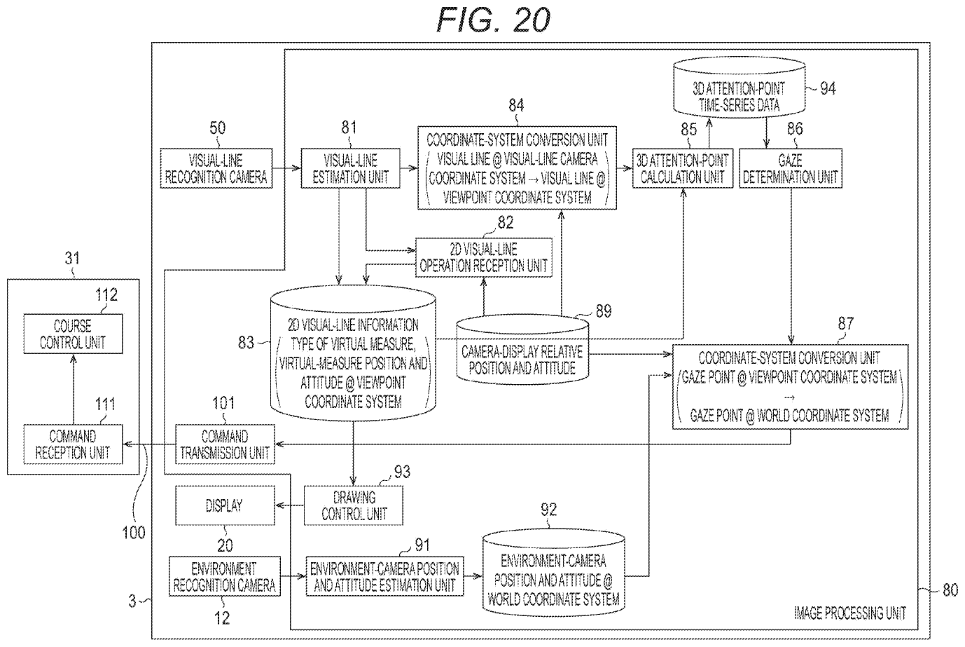

FIG. 20 is a block diagram illustrating an exemplary configuration of the wearable display device and an exemplary configuration of the drone of FIG. 19.

The wearable display device 3 of FIG. 20 includes an environment recognition camera 12, a display 20, a visual-line recognition camera 50, and an image processing unit 80. The image processing unit 80 of FIG. 20 is identical to the image processing unit 80 of FIG. 14 in terms of including a visual-line estimation unit 81, a 2D visual-line operation reception unit 82, a 2D visual-line information DB 83, a coordinate-system conversion unit 84, a 3D attention-point calculation unit 85, a gaze determination unit 86, a coordinate-system conversion unit 87, a camera-display relative position and attitude DB 89, a position and attitude estimation unit 91, an environment-camera position and attitude DB 92, a drawing control unit 93, and a 3D attention-point time-series DB 94.

The image processing unit 80 of FIG. 20 is different from the image processing unit 80 of FIG. 14 in terms of having a gaze-point DB 88 and a coordinate-system conversion unit 90 removed and having a command transmission unit 101 added. Note that the command transmission unit 101 may be regarded as an exemplary object control unit according to the present disclosure.

In other words, for example, the command transmission unit 101 transmits a 3D gaze point in a world coordinate system converted by the coordinate-system conversion unit 87, to the drone 31 through the wireless communication 100. The command transmission unit 101 can be regarded as a positional-information transmission unit that transmits positional information for moving the drone 31 as a mobile object to the 3D gaze point, to the drone 31.

In the example of FIG. 20, the drone 31 including a command reception unit 111 and a course control unit 112, performs course control to the coordinates of the 3D gaze point received from the wearable display device 3 through the wireless communication 100, and flies in accordance with the course.

The command reception unit 111 receives the coordinates of the 3D gaze point in the world coordinate system from the wearable display device 3, and supplies the coordinates of the 3D gaze point to the course control unit 112.

On the basis of the coordinates of the 3D gaze point that have been received, the course control unit 112 consecutively generates an appropriate course and calculates the course to a target value, with image sensing or ultrasonic sensing by a camera not illustrated. Note that the attitude after arrival at the destination is similar to the attitude before the departure, or can be controlled by the user 1 with a controller.

Note that the drone 31 is not limited to a drone, and thus may be a flyable robot or mobile object, or may be an unflyable robot or mobile object.

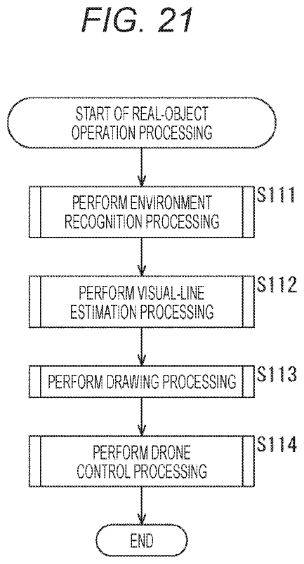

Next, real-object operation processing will be described with reference to the flowchart of FIG. 21.

An image from the environment recognition camera 12 is input into the environment-camera position and attitude estimation unit 91 At step S111, the environment-camera position and attitude estimation unit 91 performs environment recognition processing. The environment recognition processing is similar to the processing described above with reference to FIG. 16, and thus the description thereof will be omitted. The processing causes the position and attitude of the environment recognition camera 12, estimated from the image from the environment recognition camera 12, to be recorded in the environment-camera position and attitude DB 92.

Furthermore, an image input from the visual-line recognition camera 50 is input into the visual-line estimation unit 81. At step S112, the visual-line estimation unit 81, the 2D visual-line operation reception unit 82, the coordinate-system conversion unit 84, the 3D attention-point calculation unit 85, and the gaze determination unit 86 perform visual-line estimation processing. The details of the visual-line estimation processing is similar to those of the processing described above with reference to FIG. 17, and thus the descriptions thereof will be omitted. The processing causes a 2D gaze point to be acquired, a 3D gaze point to be acquired from the 2D gaze point, and the 3D gaze point to be converted into the 3D gaze point in the latest world coordinate system. The coordinates of the converted 3D gaze point in the latest world coordinate system, is supplied to the command transmission unit 101.

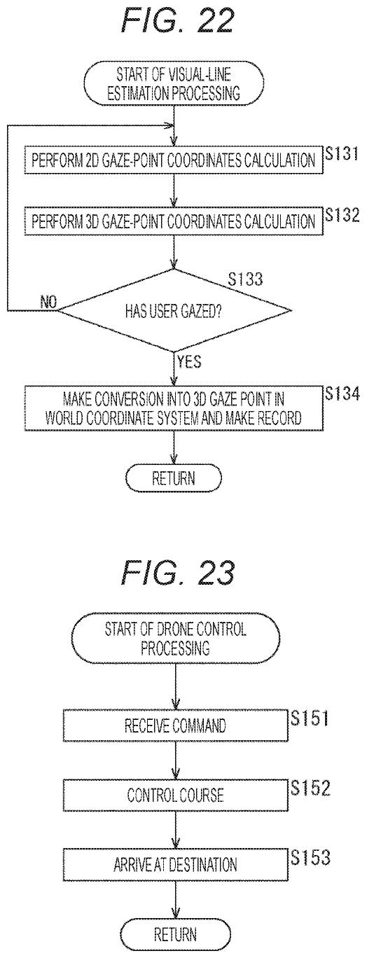

At step S113, the drawing control unit 93 performs drawing processing, with information in the 2D visual-line information DB 83. The details of the drawing processing are to be described later with reference to FIG. 22. The processing causes drawing on the display 20 with a 2D visual line and drawing of a virtual measure, to be controlled, so that the drawings are made on the display 20.

At step S114, the command transmission unit 101 performs drone control processing. The details of the drone control processing are to be described later with reference to FIG. 23. The processing causes the coordinates of the 3D gaze point (destination) in the latest world coordinate system supplied by the processing at step S112, to be received as a command by the drone 3, so that the course is controlled on the basis of the coordinates and the drone 3 arrives at the destination. Then, the real-object operation processing of FIG. 21 is finished.

Next, the visual-line estimation processing at step S112 of FIG. 21 will be described with reference to the flowchart of FIG. 22. Note that the processing at steps S131 to S133 of FIG. 22 is performed similarly to that at steps S51 to S53 of FIG. 17, and thus the description thereof will be omitted.

At step S134, with camera-display relative position and attitude data from the camera-display relative position and attitude DB 89, environment-camera position and attitude in the latest world coordinate system from the environment-camera position and attitude DB 92, and the 3D gaze point in a viewpoint coordinate system from the gaze determination unit 86, the coordinate-system conversion unit 87 converts the 3D gaze point in the viewpoint coordinate system, into the 3D gaze point in the world coordinate system, and supplies the converted 3D gaze point in the world coordinate system to the command transmission unit 101.

Next, the drone control processing at step S114 of FIG. 21 will be described with reference to the flowchart of FIG. 23.

At step S134 of FIG. 22, the coordinates of the 3D gaze point in the world coordinate system is transmitted through the command transmission unit 101. At step S151, the command reception unit 111 receives the command (the coordinates of the 3D gaze point in the world coordinate system). At step S152, the course control unit 112 controls the course of the drone 3, on the basis of the received command. At step S153, the drone 3 arrives at the destination (the 3D gaze point in the world coordinate system).

As described above, according to the present technology, an effect similar to that for the virtual object, is acquired even for the real object.

In other words, the drawing of the virtual measure enables the localization of the 3D gaze point even to midair to which the localization used to be difficult, namely, enables the localization of the visual line, so that an operation is allowed with the visual line. In other words, an improvement regarding the localization of the visual line, can be made in pointing or an object operation with the visual line. This arrangement enables the virtual object operation to be performed in a handsfree manner. Furthermore, because of the operation with the visual line, the latency of pointing is small.

Moreover, because the 3D gaze point can be acquired from the visual-line recognition and the environment recognition, even while the user is moving, a gaze state can be detected and pointing interaction can be performed.

### 4. Fourth Embodiment

### External Appearance of Wearable Display Device

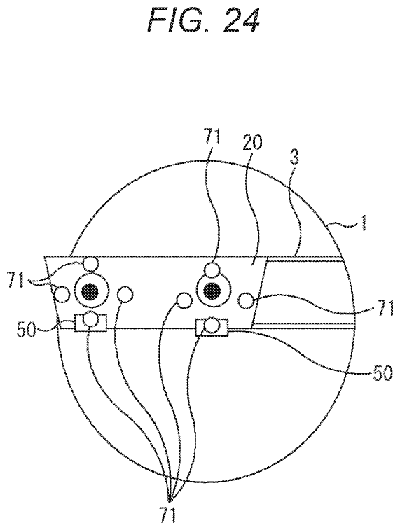

FIG. 24 is a diagram illustrating an exemplary configuration of the external appearance of a wearable display device as an image processing device that is one information processing device to which the present technology has been applied. Note that the wearable display device of FIG. 24 performs the virtual camera visual-point movement described above with reference to FIG. 4.

In the example of FIG. 24, similarly to the case of the example of FIG. 13, the wearable display device 3 has a spectacle type, and is worn on the face of a user 1. Note that, although no environment recognition camera 12 is illustrated in the example of FIG. 24, an environment recognition camera 12 is provided in practice. Although the use of the environment recognition camera 12 and the technique of the SLAM described above as the self-position estimation, has been exemplarily described in the example of FIG. 14, examples of other self-position estimation techniques include GPS, WIFI, IMU (a triaxial acceleration sensor+a triaxial gyroscope sensor), RFID, visible-light communication positioning, and object recognition (image authentication).

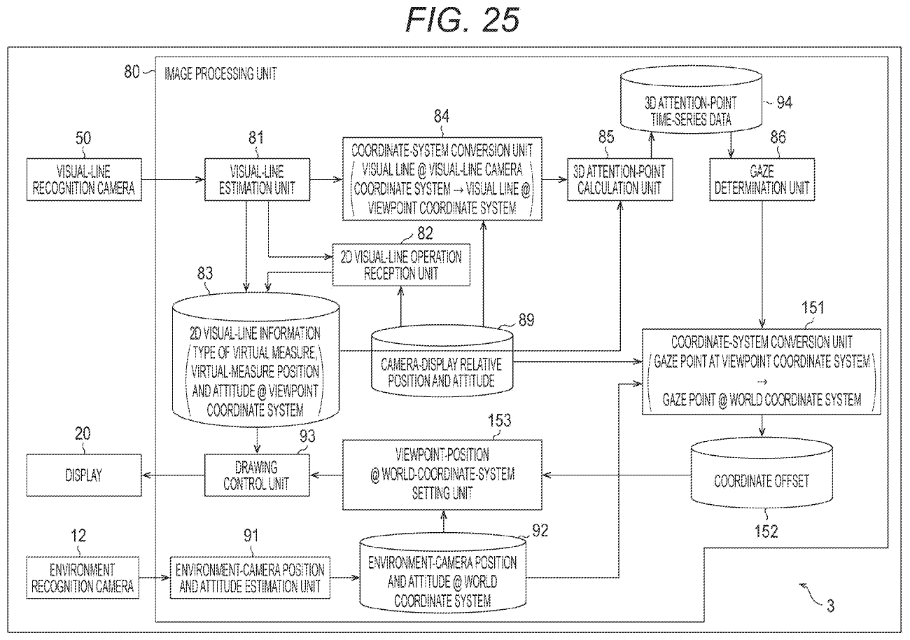

FIG. 25 is a block diagram of an exemplary configuration of the wearable display device of FIG. 24.

The wearable display device 3 of FIG. 25 includes an environment recognition camera 12, a display 20, a visual-line recognition camera 50, and an image processing unit 80. The image processing unit 80 of FIG. 25 is identical to the image processing unit 80 of FIG. 14 in terms of including a visual-line estimation unit 81, a 2D visual-line operation reception unit 82, a 2D visual-line information DB 83, a coordinate-system conversion unit 84, a 3D attention-point calculation unit 85, a gaze determination unit 86, a camera-display relative position and attitude DB 89, a position and attitude estimation unit 91, an environment-camera position and attitude DB 92, a drawing control unit 93, and a 3D attention-point time-series DB 94.

The image processing unit 80 of FIG. 25 is different from the image processing unit 80 of FIG. 14 in terms of having a coordinate-system conversion unit 87, a gaze-point DB 88, and a coordinate-system conversion unit 90 removed and having a coordinate-system conversion unit 151, a coordinate offset DB 152, and a viewpoint position setting unit 153 added.

In other words, with camera-display relative position and attitude data from the camera-display relative position and attitude DB 89, environment-camera position and attitude in the latest world coordinate system that is a world standard, from the environment-camera position and attitude DB 92, and a 3D gaze point in a viewpoint coordinate system from the gaze determination unit 86, the coordinate-system conversion unit 151 converts the 3D gaze point in the viewpoint coordinate system into the 3D gaze point in the world coordinate system, and records, as a coordinate offset, the difference between the converted 3D gaze point and the environment-camera position, into the coordinate offset DB 152. The environment-camera position is the position of the environment recognition camera 12.

The difference between the 3D gaze point converted by the coordinate-system conversion unit 151 and the environment-camera position, is recorded as the coordinate offset in the coordinate offset DB 152.

The viewpoint position setting unit 153 sets the position of a viewpoint in the latest world coordinate system, as the sum of the environment-camera position in the latest world coordinate system from the environment-camera position and attitude DB 92 and the coordinate offset acquired by the coordinate-system conversion unit 151. Note that, the attitude of the viewpoint adopts the environment-camera attitude in the latest world coordinate system from the environment-camera position and attitude DB 92, the environment-camera attitude remaining intact. The viewpoint position setting unit 153 supplies the position and the attitude of the viewpoint that have been set, to the drawing control unit 93. The viewpoint in the latest world coordinate system is a visual point from which an image (a subject viewed therein) to be displayed on the display 20 is viewed in the world coordinate system (the visual point of the camera that captures an image to be displayed on the display 20).

The drawing control unit 93 controls drawing on the display 20 with a 2D visual line and drawing of a virtual measure, based on information in the 2D visual-line information DB 83, and drawing of a virtual object, based on the position and the attitude of the viewpoint acquired by the viewpoint position setting unit 153.

Note that virtual-object operation processing in the wearable display device 3 of FIG. 25 is performed basically similarly to the virtual-object operation processing of FIG. 15, except for the details of the visual-line estimation processing at step S12. Therefore, as the operation of the wearable display device 3 of FIG. 25, only the details of different visual-line estimation processing at step S12 of FIG. 15 will be described.

### Operation of Wearable Display Device

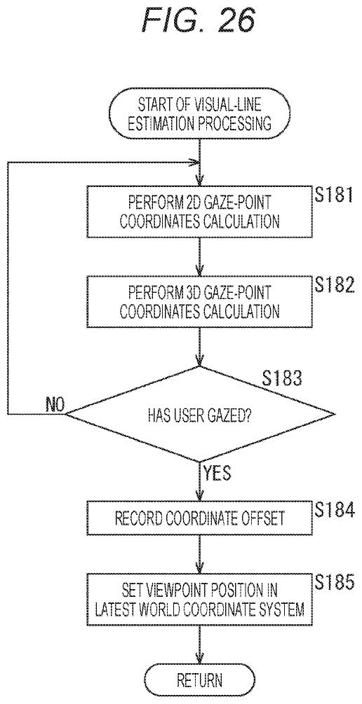

The visual-line estimation processing at step S12 of FIG. 15 will be described with reference to the flowchart of FIG. 26. Note that the processing at steps S181 to S183 of FIG. 26 is performed similarly to that at steps S51 to S53 of FIG. 17, and thus the description thereof will be omitted in order to avoid repetition.

At step S184, with the camera-display relative position and attitude data from the camera-display relative position and attitude DB 89, the environment-camera position and attitude in the latest world coordinate system that is a world standard, from the environment-camera position and attitude DB 92, and the 3D gaze point in the viewpoint coordinate system from the gaze determination unit 86, the coordinate-system conversion unit 151 converts the 3D gaze point in the viewpoint coordinate system into the 3D gaze point in the world coordinate system, and records, as the coordinate offset, the difference between the converted 3D gaze point and the environment-camera position, into the coordinate offset DB 152.

At step S185, the viewpoint position setting unit 153 sets the position of the viewpoint in the latest world coordinate system, as the sum of the environment-camera position in the latest world coordinate system from the environment-camera position and attitude DB 92 and the coordinate offset acquired by the coordinate-system conversion unit 151. Thereafter, the visual-line estimation processing finishes, and the virtual-object operation processing goes back to step S12 of FIG. 15 and proceeds to step S13.

As described above, according to the present technology, even in a case where the visual point is switched in the virtual world, an effect similar to that for the movement of the virtual object or the real object, is acquired.

In other words, the drawing of the virtual measure enables the localization of the 3D gaze point even to midair to which the localization used to be difficult, namely, enables the localization of the visual line, so that an operation is allowed with the visual line. In other words, an improvement regarding the localization of the visual line, can be made in pointing or an object operation with the visual line. This arrangement enables the virtual object operation to be performed in a handsfree manner. Furthermore, because of the operation with the visual line, the latency of pointing is small.

Moreover, because the 3D gaze point can be acquired from the visual-line recognition and the environment recognition, even while the user is moving, a gaze state can be detected and pointing interaction can be performed.

### 5. Additional Descriptions

### Relationship Between Coordinate Systems

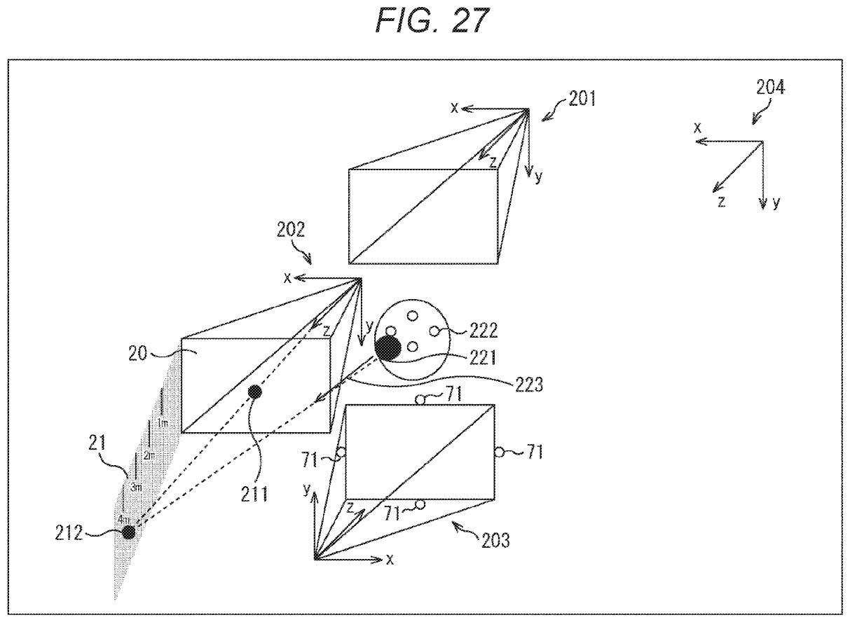

Next, the relationship between the coordinate systems according to the present technology, will be described with reference to FIG. 27.

The example of FIG. 27 indicates an environment recognition camera coordinate system 201, a viewpoint coordinate system 202, a visual-line recognition camera coordinate system 203, and a world coordinate system 204. Note that an example in which the technique of a pupillary and corneal reflex method is used, is indicated in the visual-line recognition camera coordinate system 203.

A display 20, a virtual ruler 21, a 2D gaze point 211 on the display 20, and a 3D attention point 212 on the virtual ruler 21 are indicated in the viewpoint coordinate system 202. An LED 71 having infrared light, a luminous point (Purkinje image) 222 that is a reflection in irradiation of the LED 71 to a pupil, pupillary coordinates 221, and a visual-line vector 223 acquired, in observation of the luminous point 222 and the pupil with a camera, from the positional relationship therebetween, are indicated in the visual-line recognition camera coordinate system 203.

Note that, according to the present technology, the relationship between the environment recognition camera coordinate system 201, the viewpoint coordinate system 202, and the visual-line recognition camera coordinate system 203, is known due to previous performance of calibration.

Furthermore, the world coordinate system 204 and the environment recognition camera coordinate system 201 are acquired in real time by a self-position estimation technique, such as SLAM.

### Method of Acquiring 3D Attention Point

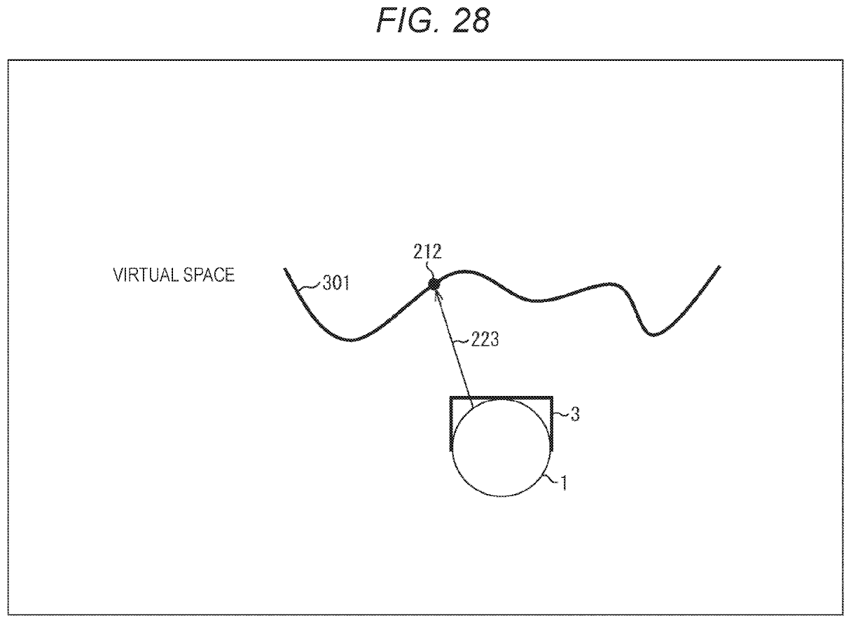

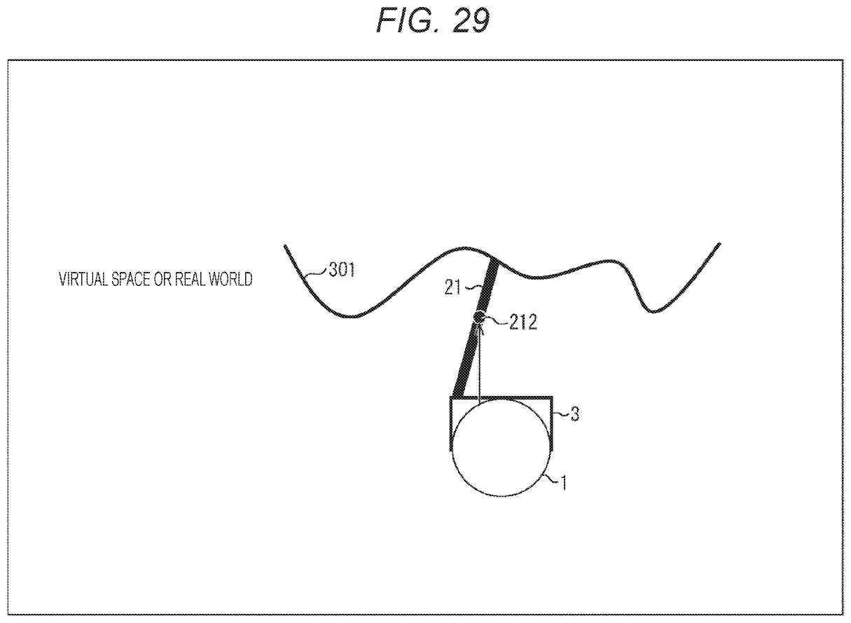

Next, a method of acquiring a 3D attention point in virtual space according to the present technology, will be described with reference to FIGS. 28 and 29.

As illustrated in FIG. 28, the intersection between an object 301 in the virtual space and the visual-line vector 223, is the 3D attention point 212. Therefore, the 3D attention point 212 can be acquired as long as at least one visual-line vector 223 of the user 1 who is wearing the wearable display device 3, is provided.

Meanwhile, as illustrated in FIG. 29, the virtual ruler 21 that is one virtual measure, is provided such that the object 301 in the virtual (real-world) space is connected with the user 1 itself, and the intersection between the virtual ruler 21 and the visual-line vector 223 is the 3D attention point 212. Therefore, the 3D attention point 212 can be acquired as long as at least one visual-line vector 223 of the user 1 who is wearing the wearable display device 3, is provided.

The 3D attention point 212 that is the intersection between the virtual ruler 21 and the visual-line vector 223, is included in an Empty Field, and the use of the virtual ruler 21 enables the visual line to be fixed on the Empty Field.

### 6. Fifth Embodiment

### Exemplary Configuration of Image Processing System

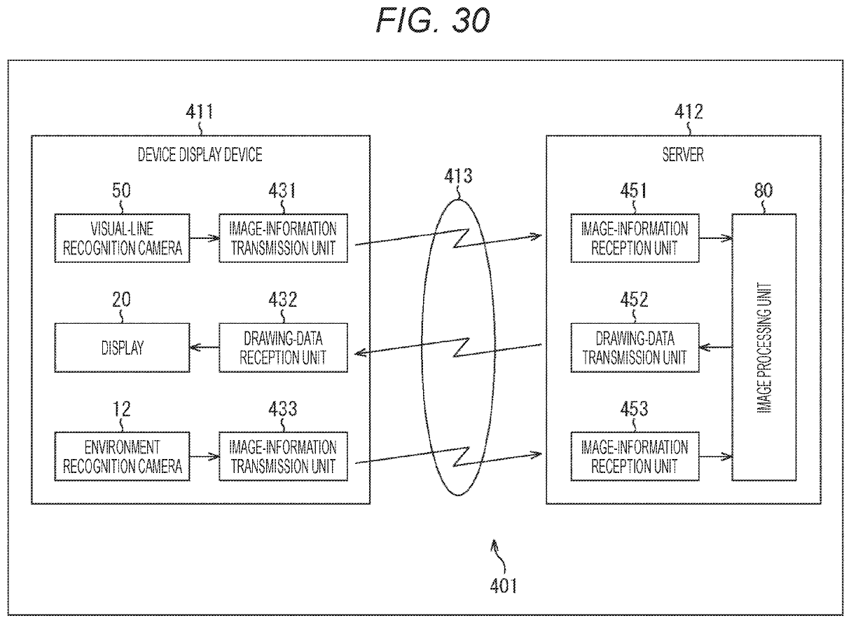

FIG. 30 is a block diagram illustrating an exemplary configuration of an image processing system to which the present technology has been applied.

In the example of FIG. 30, the image processing system 401 is a system in which a server 412 performs, as image processing, environment recognition processing, visual-line estimation processing, and drawing processing (drawing data creation processing) with information acquired in a wearable display device 411 and then created drawing data transmitted to the wearable display device 411 through a network 413 is displayed on a display 20 of the wearable display device 411.

The wearable display device 411 of FIG. 30 is identical to the wearable display device 3 of FIG. 14 in terms of including a visual-line recognition camera 50, the display 20, and an environment recognition camera 12.

The wearable display device 411 of FIG. 30 is different from the wearable display device 3 of FIG. 14 in terms of having an image processing unit 80 removed and having an image-information transmission unit 431, a drawing-data reception unit 432, and an image-information transmission unit 433 added.

Furthermore, the server 412 of FIG. 30 includes an image-information reception unit 451, a drawing-data transmission unit 452, an image-information reception unit 453, and an image processing unit 80.

In other words, the image processing unit 80 of the wearable display device 3 of FIG. 14 is not included in the wearable display device 411 but in the server 412, in the image processing system 401 of FIG. 30.

In the wearable display device 411, the image-information transmission unit 431 transmits image information input from the visual-line recognition camera 50, to the image-information reception unit 451 of the server 412 through the network 413. The drawing-data reception unit 432 receives, through the network 413, drawing data transmitted from the drawing-data transmission unit 452 of the server 412, and displays a drawing (image) corresponding to the received drawing data, on the display 20. The image-information transmission unit 433 transmits image information input from the environment recognition camera 12, to the image-information reception unit 453 of the server 412 through the network 413.

In the server 412, the image-information reception unit 451 receives the image information input from the visual-line recognition camera 50, and supplies the image information to the image processing unit 80. The drawing-data transmission unit 452 transmits the drawing data drawn by the image processing unit 80, to the wearable display device 3 through the network 413. The image-information reception unit 453 receives the image information input from the environment recognition camera 12, and supplies the image information to the image processing unit 80.

The image processing unit 80 including a visual-line estimation unit 81, a 2D visual-line operation reception unit 82, a 2D visual-line information DB 83, a coordinate-system conversion unit 84, a 3D attention-point calculation unit 85, a gaze determination unit 86, a coordinate-system conversion unit 87, a gaze-point DB 88, a camera-display relative position and attitude DB 89, a coordinate-system conversion unit 90, a position and attitude estimation unit 91, an environment-camera position and attitude DB 92, and a drawing control unit 93, similarly to the image processing unit 80 of FIG. 14, performs basically similar processing, and thus the description thereof will be omitted.

As described above, the image processing unit 80 can be provided to the server instead of being provided to the wearable display device 411. In that case, the wearable display device 411 includes the input/output, and only the part of the image processing is performed in the server 412. The created drawing data transmitted to the wearable display device 411 is displayed on the display 20.

As described above, according to the present technology, drawing of a virtual measure enables localization of a 3D gaze point even to midair to which the localization used to be difficult, namely, enables localization of a visual line, so that an operation is allowed with the visual line. In other words, an improvement regarding the localization of the visual line, can be made in pointing or an object operation with the visual line. This arrangement enables a virtual object operation to be performed in a handsfree manner. Furthermore, because of the operation with the visual line, the latency of pointing is small.

Moreover, because the 3D gaze point can be acquired from the visual-line recognition and the environment recognition, even while the user is moving, a gaze state can be detected and pointing interaction can be performed.

### Personal Computer

The pieces of processing in series described above can be performed by hardware or can be performed by software. In a case where the pieces of processing in series are performed by software, a program included in the software is installed onto a computer. Here, examples of the computer include a computer built in dedicated hardware and a general-purpose personal computer capable of performing various functions due to installation of various programs.

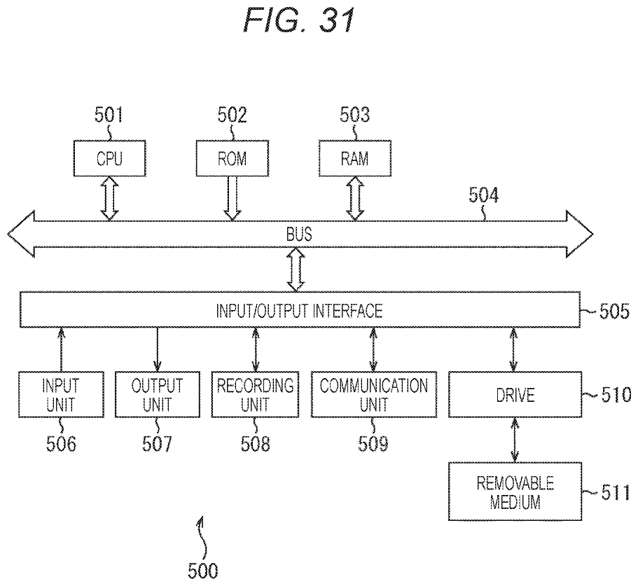

FIG. 31 is a block diagram illustrating an exemplary configuration of the hardware of a personal computer that performs the pieces of processing in series described above with a program.

The personal computer 500 has a central processing unit (CPU) 501, a read only memory (ROM) 502, a random access memory (RAM) 503 mutually connected through a bus 504.

Moreover, an input/output interface 505 is connected to the bus 504. An input unit 506, an output unit 507, a storage unit 508, a communication unit 509, and a drive 510 are connected to the input/output interface 505.

The input unit 506 includes, for example, a keyboard, a mouse, and a microphone. The output unit 507 includes, for example, a display and a speaker. The storage unit 508 includes, for example, a hard disk and a non-volatile memory. The communication unit 509 includes, for example, a network interface. The drive 510 drives a removable medium 511, such as a magnetic disk, an optical disc, a magneto-optical disc, or a semiconductor memory.

In the personal computer 500 having the configuration, the CPU 501 loads, for example, the program stored in the storage unit 508, into the RAM 503 through the input/output interface 505 and the bus 504, and executes the program. This arrangement allows the pieces of processing in series described above, to be performed.

The program to be executed by the computer (CPU 501) can be provided, the program being recorded in the removable medium 511. The removable medium 511 is a packaged medium or the like including, for example, a magnetic disk (a flexible disk included), an optical disc (e.g., a compact disc-read only memory (CD-ROM) or a digital versatile disc (DVD)), a magneto-optical disc, a semiconductor memory, or the like. Alternatively, the program can be provided through a wired or wireless transfer medium, such as a local area network, the Internet, or digital satellite broadcasting.

In the computer, putting the removable medium 511 into the drive 510 enables the program to be installed onto the storage unit 508 through the input/output interface 505. Alternatively, receiving the program with the communication unit 509 through the wired or wireless transfer medium, enables the program to be installed onto the storage unit 508. In addition, the program can be previously installed onto the ROM 502 or the storage unit 508.

Note that the program to be executed by the computer may be a program for performing the processing on a time-series basis in the order described in the present specification, or may be a program for performing the processing in parallel or at a necessary stage at which a call is made, for example.

Furthermore, in the present specification, the steps at which the program recorded in the recording medium is described, include not only the processing to be performed on a time series basis in the described order but also the processing to be performed in parallel or individually even when the processing is not necessarily performed on the time series basis.

Furthermore, in the present specification, the system means the entire device including a plurality of devices.

For example, the present disclosure can have the configuration of cloud computing in which a plurality of devices performs processing in cooperation, the devices each having one function allocated through a network.

Note that the program to be executed by the computer may be a program for performing the processing on a time-series basis in the order described in the present specification, or may be a program for performing the processing in parallel or at a necessary stage at which a call is made, for example.

Furthermore, in the present specification, the steps at which the program recorded in the recording medium is described, include not only the processing to be performed on a time series basis in the described order but also the processing to be performed in parallel or individually even when the processing is not necessarily performed on the time series basis.

Furthermore, in the present specification, the system means the entire device including a plurality of devices.

For example, the present disclosure can have the configuration of cloud computing in which a plurality of devices performs processing in cooperation, the devices each having one function allocated through a network.

Furthermore, a configuration described above as one device (or one processing unit) may be divided to form a plurality of devices (or processing units). Conversely, configurations described above as a plurality of devices (or processing units) may be collectively formed to form one device (or one processing unit). Furthermore, the configuration of each device (or each processing unit) may be added with a configuration other than the configurations described above. Moreover, as long as the configuration or the operation of the entire system remains substantially the same, the configuration of a device (or a processing unit) may be partially included in the configuration of a different device (or a different processing unit). That is, the present technology is not limited to the embodiments described above, and thus various alterations may be made without departing from the scope of the spirit of the present technology.

The preferred embodiments of the present disclosure have been described in detail with reference to the attached drawings, but the present disclosure is not limited to the examples. It is obvious that a person skilled in the technical field to which the present disclosure belongs may conceive various alterations or modifications in the scope of the technical idea described in the claims, and thus it is understood that these rightfully belong to the technical scope of the present disclosure.

Note that the present technology can also have the following configurations.

(A1)

An information processing device including:

a display control unit configured to control a display device such that a stereoscopic object is displayed, the stereoscopic object being disposed in a predetermined direction in a visual field of a user, the stereoscopic object indicating distance regarding the predetermined direction.

(A2)

The information processing device described in (A1), in which the display control unit controls the display device such that the stereoscopic object is displayed in midair in which no object visible stereoscopically in real space is present.

(A3)

The information processing device described in (A2), in which the display control unit controls the display device such that the stereoscopic object is displayed, on the basis of retention of a visual line of the user in a region of the midair.

(A4)

The information processing device described in any of (A1) to (A3), further including:

a gaze determination unit configured to determine a gaze of the user, on the basis of an intersection between a visual line of the user and the stereoscopic object.

(A5)

The information processing device described in (A4), further including:

an object control unit configured to control a predetermined object in accordance with the intersection, on the basis of the gaze of the user.

(A6)

The information processing device described in (A5), in which the object control unit controls the display device such that a predetermined virtual object is displayed at the intersection.

(A7)

The information processing device described in (A5), in which the object control unit controls movement of a mobile object in accordance with the intersection.

(A8)

The information processing device described in (A7), in which the mobile object includes a drone.

(A9)

The information processing device described in (A4), in which the display control unit controls the display device such that a visual point from which an image to be displayed is viewed is switched to a visual point corresponding to the intersection, on the basis of the gaze of the user.

(A10)

The information processing device described in any of (A4) to (A9), further including:

a camera configured to capture the user; and

a visual-line estimation unit configured to estimate the visual line of the user with the image captured by the camera.

(A11)

The information processing device described in (A10), in which the visual-line estimation unit estimates the visual line of the user with a corneal reflex method.

(A12)

The information processing device described in any of (A1) to (A11), in which the stereoscopic object has a scale having substantially regular intervals.

(A13)

The information processing device described in any of (A1) to (A11), in which the stereoscopic object includes a plurality of virtual objects disposed at substantially regular intervals.

(A14)

The information processing device described in (A13), in which the display control unit controls the display device such that the display of at least one of the plurality of virtual objects is changed or additional information regarding at least one of the plurality of virtual objects is displayed in accordance with a visual line of the user.

(A15)

The information processing device described in any of (A1) to (A14), in which the information processing device includes a head-mounted display further including the display device.

(A16)

The information processing device described in (A15), in which the display device includes a see-through display.

(A17)

The information processing device described in any of (A1) to (A16), in which the predetermined direction includes a depth direction extending ahead of the user.

(A18)

The information processing device described in any of (A1) to (A17), in which the predetermined direction includes a horizontal direction.

(A19)

An information processing method including:

controlling a display device such that a stereoscopic object is displayed, the stereoscopic object being disposed in a predetermined direction in a visual field of a user, the stereoscopic object indicating distance regarding the predetermined direction.

(A20)

A recording medium recording a program for causing a computer to function as a display control unit configured to control a display device such that a stereoscopic object is displayed, the stereoscopic object being disposed in a predetermined direction in a visual field of a user, the stereoscopic object indicating distance regarding the predetermined direction.

(B1)

An image processing device including:

a position and attitude estimation unit configured to estimate a position and an attitude of a user in real-world or virtual three-dimensional space;

a visual-line estimation unit configured to estimate a visual line of the user;

a display control unit configured to control display of a virtual measure; and

a gaze determination unit configured to determine a gaze of the user with an attention point in the real-world or virtual three-dimensional space, the attention point being an intersection between the visual-line of the user and the virtual measure.

(B2)

The image processing device described in the (B1), further including:

a gaze-point calculation unit configured to calculate a gaze point in the virtual three-dimensional space, on the basis of the position and the attitude estimated by the position and attitude estimation unit, and an intersection between a vector of the visual line of the user estimated by the visual-line estimation unit and the virtual measure or the virtual three-dimensional space.

(B3)

The image processing device described in the (B1) or (B2), in which the virtual measure includes a ruler having a scale.

(B4)

The image processing device described in the (B3), in which the display control unit causes, such that a position on the virtual measure at which the visual line of the user is fixed is clarified, the position to be displayed.

(B5)

The image processing device described in the (B1) or (B2), in which the virtual measure includes a plurality of spheres disposed at regular intervals.

(B6)

The image processing device described in the (B5), in which the display control unit causes the sphere at which the visual line of the user is fixed, to be displayed such that a color of the sphere is changed.

(B7)

The image processing device described in the (B5) or (B6), in which the display control unit controls display of additional information to only the sphere at which the visual line of the user is fixed.

(B8)

The image processing device described in any of the (B1) to (B7), in which the display control unit controls display of a virtual thing at a position of the gaze of the user determined by the gaze determination unit.

(B9)

The image processing device described in any of the (B1) to (B8), further including:

a positional-information transmission unit configured to transmit positional information for moving a mobile object to the position of the gaze of the user determined by the gaze determination unit, to the mobile object.

(B10)

The image processing device described in (B9), in which the mobile object includes a flyable object.

(B11)

The image processing device described in any of the (B1) to (B10), in which the display control unit controls display such that a visual point is switched to the position of the gaze of the user determined by the gaze determination unit.

(B12)

The image processing device described in any of the (B1) to (B11), in which the position and attitude estimation unit estimates the position and the attitude of the user with simultaneous localization and mapping (SLAM).

(B13)

The image processing device described in any of the (B1) to (B12), in which the visual-line estimation unit estimates the visual line of the user with a corneal reflex method.

(B14)

The image processing device described in any of the (B1) to (B12), in which the image processing device has a spectacle shape.

(B15)

The image processing device described in any of the (B1) to (B13), further including:

a display unit.

(B16)

The image processing device described in the (B15), in which the display unit includes a see-through display.

(B17)

The image processing device described in any of the (B1) to (B16), further including:

a visual-line recognition camera configured to recognize the visual line of the user.

(B18)

The image processing device described in any of the (B1) to (B17), further including:

an environment recognition camera configured to recognize an environment in the real-world or virtual three-dimensional space.

(B19)

An image processing method with an image processing device, the image processing method including:

estimating a position and an attitude of a user in real-world or virtual three-dimensional space;

estimating a visual line of the user;

controlling display of a virtual measure; and

determining a gaze of the user with an attention point in the real-world or virtual three-dimensional space, the attention point being an intersection between the visual line of the user and the virtual measure.

(B20)

A recording medium recording a program for causing a computer to function as:

a position and attitude estimation unit configured to estimate a position and an attitude of a user in real-world or virtual three-dimensional space;

a visual-line estimation unit configured to estimate a visual line of the user;

a display control unit configured to control display of a virtual measure; and

a gaze determination unit configured to determine a gaze of the user with an attention point in the real-world or virtual three-dimensional space, the attention point being an intersection between the visual-line of the user and the virtual measure.

### REFERENCE SIGNS LIST

1 User
3 Wearable display device
4 Virtual measure
11 Real-world three-dimensional space (or virtual three-dimensional space)
12 Environment recognition camera
13 Table
14 Empty-field
20, 20-1, 20-2 Display
20A Right-eye display unit
20B Left-eye display unit
21 Virtual ruler
22 Desired position
23 Progress mark
24 Virtual thing
25 Retention-level threshold range
31 Drone
32 Real-world three-dimensional space
35 Virtual three-dimensional space
41 Sphere
42 2D visual-point pointer
42 Setting button
51 Provisionally-setting button
52 Cancel button
53 Object
55 Object
61 3D gaze point
70 Visual-line recognition camera
71 LED
80 Image processing unit
81 Visual-line estimation unit
82 2D visual-line operation reception unit
83 2D visual-line information DB
84 Coordinate-system conversion unit
85 3D attention-point calculation unit
86 Gaze determination unit
87 Coordinate-system conversion unit
88 Gaze-point DB
89 Camera-display relative position and attitude DB
90 Coordinate-system conversion unit
91 Position and attitude estimation unit
92 Camera position and attitude DB
93 Drawing control unit
101 Command transmission unit
111 Command reception unit
112 Course control unit
151 Coordinate conversion unit
152 Coordinate offset DB
153 Viewpoint position setting unit
201 Environment recognition camera coordinate system
202 Viewpoint coordinate system
203 Visual-line recognition camera coordinate system
203 World coordinate system
211 2D gaze point
212 3D gaze point
221 Pupillary coordinates
222 Luminous point
223 Visual-line vector
301 Object
401 Image processing system
411 Wearable display device
412 Server
413 Network
431 Image-information transmission unit
432 Drawing-data reception unit
433 Image-information transmission unit
451 Image-information reception unit
452 Drawing-data transmission unit
453 Image-information reception unit

1. An information processing device comprising:
a display control unit configured to control a display device such that a stereoscopic object is displayed, the stereoscopic object being disposed in a predetermined direction in a visual field of a user, the stereoscopic object indicating distance regarding the predetermined direction.

2. The information processing device according to claim 1, wherein the display control unit controls the display device such that the stereoscopic object is displayed in midair in which no object visible stereoscopically in real space is present.

3. The information processing device according to claim 2, wherein the display control unit controls the display device such that the stereoscopic object is displayed, on the basis of retention of a visual line of the user in a region of the midair.

4. The information processing device according to claim 1, further comprising:
a gaze determination unit configured to determine a gaze of the user, on the basis of an intersection between a visual line of the user and the stereoscopic object.

5. The information processing device according to claim 4, further comprising:
an object control unit configured to control a predetermined object in accordance with the intersection, on the basis of the gaze of the user.

6. The information processing device according to claim 5, wherein the object control unit controls the display device such that a predetermined virtual object is displayed at the intersection.

7. The information processing device according to claim 5, wherein the object control unit controls movement of a mobile object in accordance with the intersection.

8. The information processing device according to claim 7, wherein the mobile object includes a drone.

9. The information processing device according to claim 4, wherein the display control unit controls the display device such that a visual point from which an image to be displayed is viewed is switched to a visual point corresponding to the intersection, on the basis of the gaze of the user.

10. The information processing device according to claim 4, further comprising:
a camera configured to capture the user; and
a visual-line estimation unit configured to estimate the visual line of the user with the image captured by the camera.

11. The information processing device according to claim 10, wherein the visual-line estimation unit estimates the visual line of the user with a corneal reflex method.

12. The information processing device according to claim 1, wherein the stereoscopic object has a scale having substantially regular intervals.

13. The information processing device according to claim 1, wherein the stereoscopic object includes a plurality of virtual objects disposed at substantially regular intervals.

14. The information processing device according to claim 13, wherein the display control unit controls the display device such that the display of at least one of the plurality of virtual objects is changed or additional information regarding at least one of the plurality of virtual objects is displayed in accordance with a visual line of the user.

15. The information processing device according to claim 1, wherein the information processing device includes a head-mounted display further including the display device.

16. The information processing device according to claim 15, wherein the display device includes a see-through display.

17. The information processing device according to claim 1, wherein the predetermined direction includes a depth direction extending ahead of the user.

18. The information processing device according to claim 1, wherein the predetermined direction includes a horizontal direction.

19. An information processing method comprising:
controlling a display device such that a stereoscopic object is displayed, the stereoscopic object being disposed in a predetermined direction in a visual field of a user, the stereoscopic object indicating distance regarding the predetermined direction.

20. A recording medium recording a program for causing a computer to function as a display control unit configured to control a display device such that a stereoscopic object is displayed, the stereoscopic object being disposed in a predetermined direction in a visual field of a user, the stereoscopic object indicating distance regarding the predetermined direction.
